(19) United States
(12) Patent Application Publication
(10) Pub. No.: US 2015/0256649 A1
(43) Pub. Date: Sep. 10, 2015

(54) IDENTIFICATION APPARATUS AND IDENTIFICATION METHOD

(71) Applicant: FUJITSU LIMITED, Kawasaki-shi (JP)

(72) Inventor: Tetsuya Nishi, Kawasaki (JP)

(21) Appl. No.: 14/609,511

(22) Filed: Jan. 30, 2015

(30) Foreign Application Priority Data
Mar. 7, 2014 (JP) 2014-045751

(51) Int. Cl. H04L 29/06; H04L 12/26

(52) U.S. Cl. CPC H04L 67/42; H04L 43/0829

(57) ABSTRACT

An identification apparatus includes a processor which executes a process. The process includes acquiring information that includes an amount of information that is communicated between a plurality of communication apparatuses that communicate information, and identifying as a server apparatus a first communication apparatus that is any of the plurality of communication apparatuses, when an amount of information that is output from the first communication apparatus is equal to or greater than an amount of information that is input to the first communication apparatus in communication in a specified time period between the first communication apparatus and the one or more communication apparatuses that communicate with the first communication apparatus.

### CROSS-REFERENCE TO RELATED APPLICATION

This application is based upon and claims the benefit of priority of the prior Japanese Patent Application No. 2014-045751, filed on Mar. 7, 2014, the entire contents of which are incorporated herein by reference.

### FIELD

The embodiments discussed herein are related to apparatus identification.

### BACKGROUND

Ina system that includes a server and a client, etc., an abnormality in a terminal that is connected to a network or an abnormality in a communication path (link) is considered to be a cause of interruptions in a network communication. The server is a terminal that provides a specified service to another terminal via the network, and the client is a terminal that uses the service that is provided by the server. The client is a terminal that transmits a request in a certain flow, and the server is a terminal that transmits a response to the request from the client. A data amount that is input from the server to the client is greater than a data amount that is output from the client to each server in a specified time. On the other hand, a data amount that is output from the server to the client is greater than a data amount that is input from each client to the server in a specified time period.

Here, a degree of urgency in failure handling changes depending on whether an apparatus that is connected to a link in which a failure has occurred is a server or a client. Therefore, identification as to whether each terminal of a system is a server or not is required. Such identification as to whether each terminal of a system is a server or not is performed on the basis of configuration information that is registered by a system administrator.

However, for example, a cloud system administrator is unable to know whether or not a terminal that is constructed by a user in a cloud system is a server. In addition, there is a problem wherein an error in configuration information that is registered by the administrator leads to a wrong analysis of an abnormal portion.

On the other hand, there is an identifying technique for identifying a communication apparatus that corresponds to a client and a communication apparatus that corresponds to a server from information that is included in packets. The identifying technique acquires packets that are transmitted or received by a communication apparatus, and measures a time interval of switching between a packet transmission destination and a packet transmission source in the same session on the basis of a combination of a packet transmission destination address and a packet transmission source address. On the basis of a measurement result, the identifying technique judges whether the packet transmission source or the packet transmission destination corresponds to the server or the client.

Techniques that are described in the following documents are known.

Japanese Laid-open Patent Publication No. 2011-199788

Japanese Laid-open Patent Publication No. 2007-207190

### SUMMARY

According to an aspect of the embodiment, an identification apparatus includes a processor which executes a process. The process includes acquiring information that includes an amount of information that is communicated between a plurality of communication apparatuses that communicate information, and identifying as a server apparatus a first communication apparatus that is any of the plurality of communication apparatuses, when an amount of information that is output from the first communication apparatus is equal to or greater than an amount of information that is input to the first communication apparatus in communication in a specified time period between the first communication apparatus and the one or more communication apparatuses that communicate with the first communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of a working example of an identification apparatus.

FIG. 2 represents an example of a configuration of an information processing system according to the embodiment.

FIG. 3 is a diagram explaining network failure monitoring with a network tomography technique.

FIG. 4 is an example of network tomography link information.

FIG. 5 is an example of a failure in network failure monitoring using the network tomography technique.

FIG. 6 is a diagram explaining a server identification process based on the comparison between an input data amount and an output data amount.

FIG. 7 is a diagram (part 1) explaining a server identification process based on a correlation between communication data amounts.

FIGS. 8A and 8B are diagrams (part 2) explaining a server identification process based on a correlation between communication data amounts.

FIGS. 9A, 9B and 9C represent an example of a change in a terminal input data amount that is used in a server specifying process based on a communication data amount for a long time period.

FIGS. 10A and 10B are diagrams explaining a change in a communication data amount between a maintenance target terminal and a maintenance terminal when a failure occurs.

FIG. 11 represents an example of a configuration of a monitoring apparatus.

FIGS. 12A and 12B represent an example of topology information.

FIGS. 13A and 13B represent an example of flow information.

FIG. 14 represents an example of link information.

FIG. 15 represents an example of path information.

FIG. 16 represents an example of flow management information.

FIG. 17 represents an example of decision result information.

FIG. 18 represents an example of information on undetermined terminals.

FIG. 19 represents an example of traffic information.

FIG. 20 represents an example of traffic management information that is used in a server identification process based on a communication data amount for a long time period.

FIG. 21 represents an example of maintenance management information.

FIG. 22 represents an example of flow-state management information.

FIG. 23 is an example of information that is output by an output unit.

FIG. 24 is a flowchart (part 1) illustrating details of a server identification process.

FIG. 25 is a flowchart (part 2) illustrating details of the server identification process.

FIG. 26 is a flowchart (part 3) illustrating details of the server identification process.

FIG. 27 is a flowchart (part 4) illustrating details of the server identification process.

FIG. 28 is a flowchart (part 5) illustrating details of the server identification process.

FIG. 29 is a flowchart illustrating details of a failure specifying process based on a communication data amount of a terminal.

FIG. 30 is a flowchart illustrating details of a failure specifying process using network tomography.

FIG. 31 is an example of a hardware configuration of a monitoring apparatus.

### DESCRIPTION OF EMBODIMENTS

Since an identification apparatus that identifies a server from acquired packet information cannot analyze a content by acquiring packets that are communicated by a terminal that is managed by a customer in a cloud system, the identification apparatus cannot be applied to a system such as the cloud system in some cases.

An identification apparatus according to the embodiment can identify whether a communication apparatus is a server or not from information related to communication between communication apparatuses.

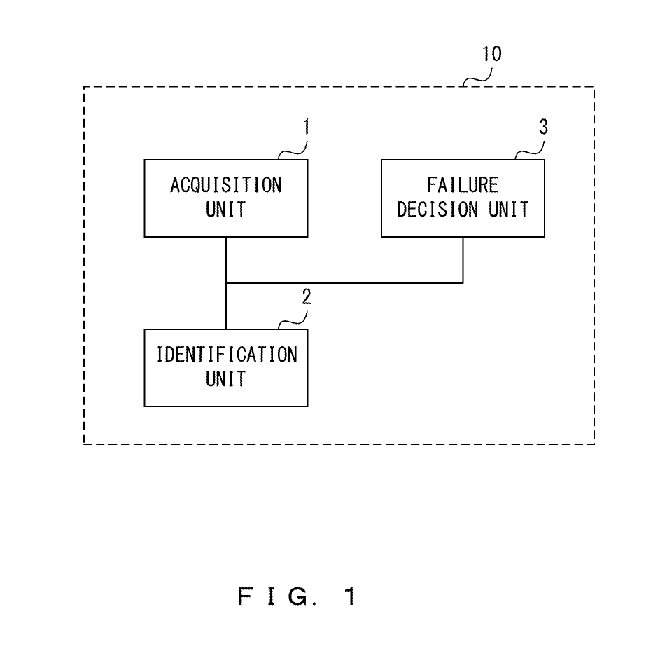

FIG. 1 is a functional block diagram illustrating a configuration of a working example of the identification apparatus. In FIG. 1, the identification apparatus 10 includes an acquisition unit 1, an identification unit 2, and a failure decision unit 3.

The acquisition unit 1 acquires information that includes an amount of information that is communicated between a plurality of communication apparatuses that communicate information.

The identification unit 2 identifies as a server apparatus a first communication apparatus, which is any one of the plurality of communication apparatuses, when an amount of information that is output from the first communication apparatus is equal to or greater than an amount of information that is input to the first communication apparatus in a communication for a specified time period between the first communication apparatus and one or more communication apparatuses that communicate with the first communication apparatus.

The acquisition unit 1 acquires, from a controller that controls a relay apparatus that relays communication between the plurality of communication apparatuses, information that includes an amount of information that is communicated between the plurality of communication apparatuses.

The identification unit 2 identifies the first communication apparatus as the server apparatus when an amount of information that is output from the first communication apparatus is equal to or greater than an amount of information that is input to the first communication apparatus during communication for a specified time period that is performed between the first communication apparatus and each of the one or more communication apparatuses that communicate with the first communication apparatus.

When the identification unit 2 identifies the first communication apparatus as the server apparatus, the identification unit 2 identifies as a server apparatus a second communication apparatus that is one of the plurality of communication apparatuses and that communicates with the first communication apparatus, when an amount of information that is output from the second communication apparatus is greater than an amount of information that is input to the second communication apparatus during communication for a specified time period that is performed between the second communication apparatus and one or more communication apparatuses that communicate with the second communication apparatus and that are different from the first communication apparatus.

The identification unit 2 identifies as server apparatuses the first communication apparatus and a third communication apparatus that is any of the plurality of communication apparatuses, when there is a correlation between a communication amount of the first communication apparatus and a communication amount of the third communication apparatus in a specified time period.

The identification unit 2 calculates a first threshold value on the basis of an average or variance of a communication amount for each specified time interval in a first time period for each of the first communication apparatus and the third communication apparatus, specifies a time period of the specified time interval in which the communication amount is equal to or greater than the first threshold value and the communication amount is maximal in the first time period, and identifies the first communication apparatus and the third communication apparatus as server apparatuses when the specified time period of the first communication apparatus agrees with that of the third communication apparatus.

The failure decision unit 3 calculates a second threshold value on the basis of an average or variance of a communication amount for each specified time interval in a second time period of the first communication apparatus, and when a communication amount of the first communication apparatus is less than a second threshold value and when the first communication apparatus communicates with all of the plurality of communication apparatuses in the second time period, the failure decision unit 3 judges that a failure has occurred in a fourth communication apparatus that communicates with the first communication apparatus, when an amount of information that is communicated in a specified time period between the first communication apparatus and the fourth communication apparatus is equal to or greater than a specified threshold value and when there is no information that is output from the fourth communication apparatus even though there is information that is input to the fourth communication apparatus in communication between the fourth communication apparatus and each of one or more communication apparatuses that communicate with the fourth communication apparatus.

Thus, identification of a server apparatus is made possible from information related to communication between terminals without analyzing the content of each packet.

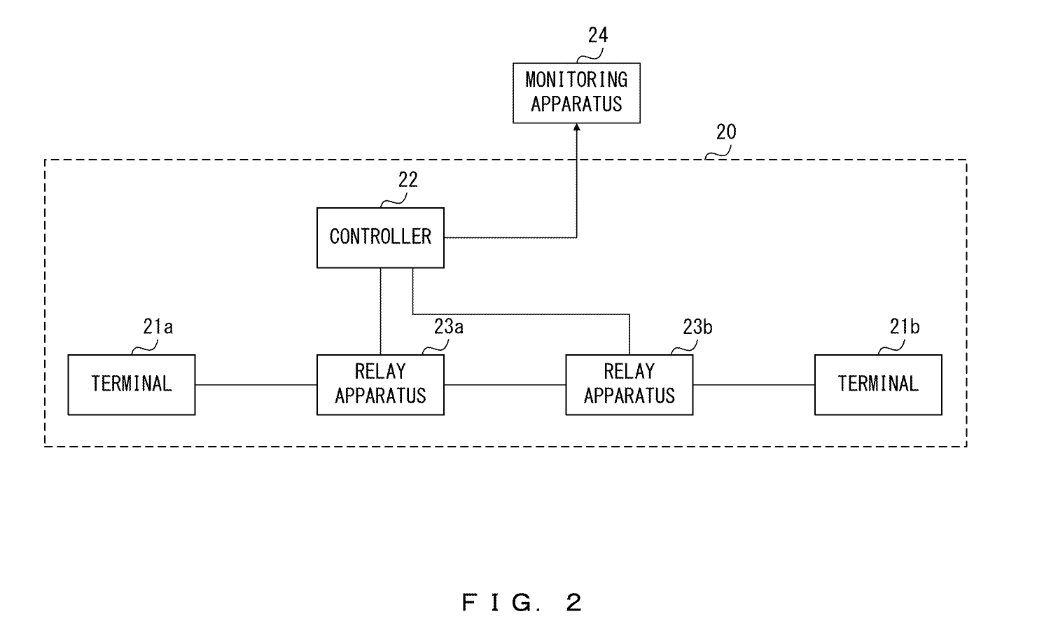

FIG. 2 represents an example of a configuration of an information processing system according to the embodiment. In FIG. 2, the information processing system includes terminals 21 (21a and 21b), a controller 22, relay apparatuses 23 (23a and 23b), and a monitoring apparatus 24. In a network 20 of the information processing system, for example, an OpenFlow technology is used. The monitoring apparatus 24 is an example of the identification apparatus 10.

The terminal 21 communicates information via the relay apparatus 23.

The controller 22 controls an operation of each relay apparatus 23, and collects statistical information related to communication from each relay apparatus 23. The statistical information includes information that indicates a communication amount (traffic amount). For example, the statistical information is summarized for each set of communications with the same attribute. Here, an attribute means any of or a combination of attributes that are related to communication, such as a “destination MAC address”, a “source MAC address”, a “destination IP address”, a “source IP address”, a “destination port number”, a “source port number”, and “an ID of a VLAN.” For example, traffics having the same set of the “source MAC address” and the “destination MAC address” are communications of the same attribute. A set of communications with the same attribute is called a flow.

In addition, the controller 22 detects topology information (information that is related to a connection relationship between switches) of the network 20.

For example, when the OpenFlow technology is used in the network 20, the controller 22 is an OpenFlow switch controller (OFS controller), controls an operation of the relay apparatus 23 by using an OpenFlow protocol, and collects statistical information. In addition, the controller 22 collects topology information of the network 20 by using, for example, an LLDP (Link Layer Discovery Protocol).

The relay apparatus 23 relays communication between the terminals 21. The relay apparatus 23 operates according to a rule that is prescribed by the controller 22, and transmits to the controller 22 information related to communication that is relayed. For example, when the OpenFlow technology is used in the network 20, the relay apparatus 23 is an OpenFlow switch (OFS), and executes a process on the basis of the rule that is prescribed by the controller 22 (OFS controller). This rule includes a flow table that indicates which path is selected when a received packet (frame) is transferred. In the flow table, conditions (match fields) and actions (instructions) that are associated with respective conditions are prescribed, and when the relay apparatus 23 receives a packet that matches a condition, the relay apparatus 23 executes an action that corresponds to the condition. A set of communications with the same attribute that follows the definition of the combination of the condition and the action is an example of the flow. The flow table includes statistical information (counters) for each flow, and the statistical information includes information that indicates a traffic amount of each flow. The statistical information is transmitted to the OFS controller and is summarized. The relay apparatus 23 is allocated with a switch ID, which is information for the controller 22 to uniquely identify the relay apparatus 23.

The monitoring apparatus 24 acquires topology information of the network 20 and statistical information from the controller 22, and monitors a failure of the network 20 by using the acquired information. Specifically, the monitoring apparatus 24 executes a specifying process of a failure portion (section) on a communication path based on a redundancy of paths on which a failure has occurred from among paths on which information between the terminals 21 is communicated. For example, the monitoring apparatus 24 monitors a failure of the network 20 with a network tomography technique.

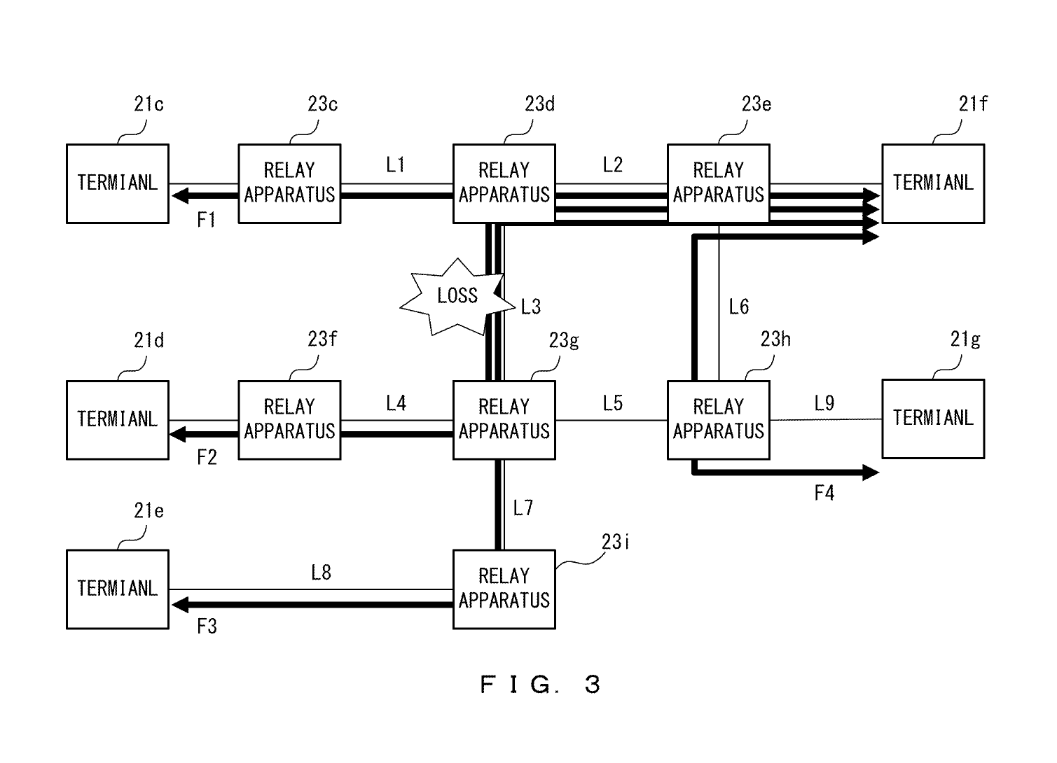

Here, operations for monitoring a network failure using the network tomography technique will be described. FIG. 3 is a diagram explaining network failure monitoring using the network tomography technology. In FIG. 3, terminals 21 (21c-21g) are connected with one another via relay apparatuses 23 (23c-23i), and data communication is performed between the terminals. Although not shown in FIG. 3, each relay apparatus 23 is connected to the controller 22 via a network, and the controller 22 is connected to the monitoring apparatus 24 via the network. In the following description, each path between the relay apparatuses on (via) which data is communicated in a flow is referred to as a link. Terminals between which data is communicated in a flow are referred to as “are connected logically”. In FIG. 3, flows are illustrated as F1-F4, and links are illustrated as L1-L9. Here, in FIG. 3, a packet loss is generated in the link L3

At that time, the monitoring apparatus 24, not shown in FIG. 3, acquires via the controller 22, not shown in FIG. 3, the number of packets that are transmitted and received in a unit time between two terminals or between two relay apparatuses in each flow. The monitoring apparatus 24 judges whether each flow is normal or not on the basis of the number of acquired packets. For example, when a specified number or more of losses are generated in packets that are transmitted and received between terminals or between relay apparatuses, the monitoring apparatus 24 judges that the flow is abnormal. The monitoring apparatus 24 generates network tomography link information in which information that indicates whether each flow is normal or not is associated with identification information of a link through which data that is communicated in each flow passes.

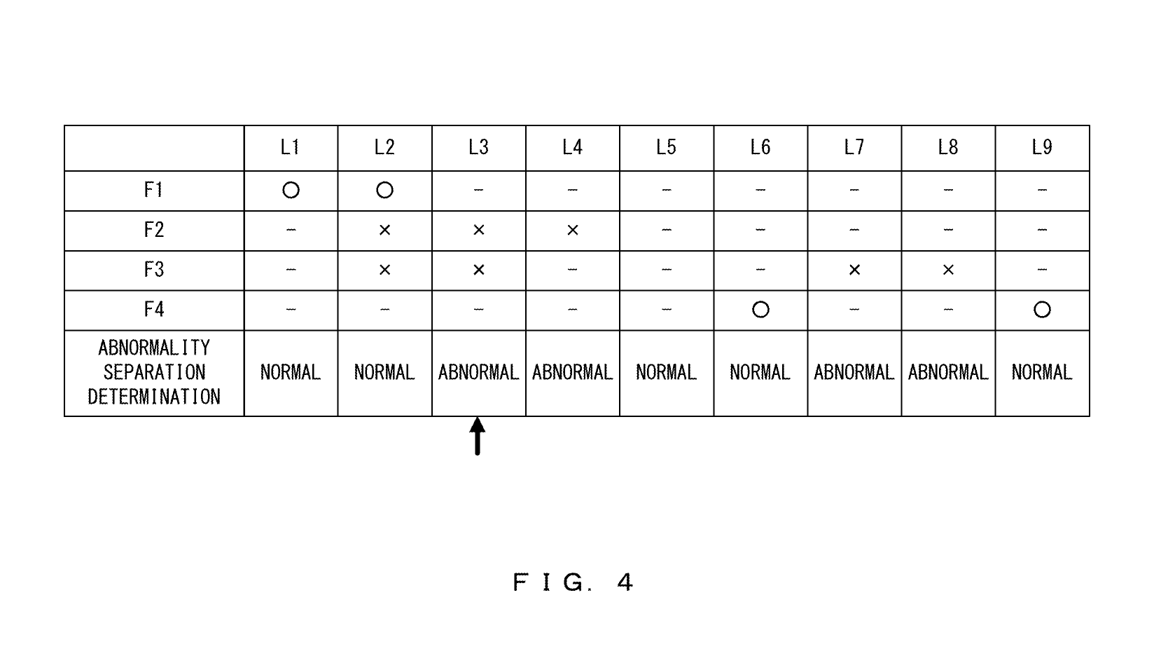

FIG. 4 is an example of network tomography link information. FIG. 4 illustrates that the links L1 and L2 in which data of the flow F1 is communicated and the links L6 and L9 in which data of the flow F4 is communicated are normal. FIG. 4 also illustrates that the links L2, L3 and L4 in which the data of the flow F2 is communicated and the links L2, L3, L7 and L8 in which data of the flow F3 is communicated are abnormal. Here, the monitoring apparatus 24 judges to be normal a link through which at least one normal flow passes, and judges to be abnormal a link through which all the abnormal flows pass. In the example in FIGS. 4, F2 and F3 are abnormal flows, and L3 is the link through which these two flows pass. Therefore, the monitoring apparatus 24 judges that L3 is abnormal.

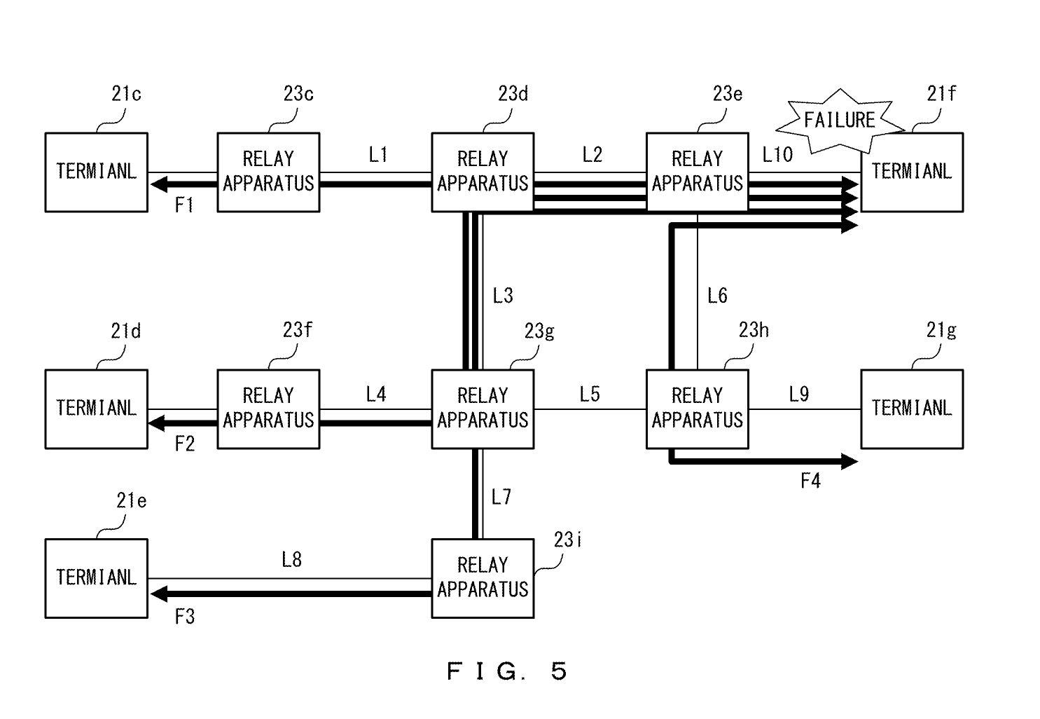

As described above, the monitoring apparatus 24 monitors a network failure by using network tomography. That is, the monitoring apparatus 24 executes a specifying process of a link in which a failure has occurred on the basis of redundancy of a flow in which a failure has occurred. However, in network failure monitoring using network tomography, there are cases in which it cannot be discriminated whether a failure has occurred in a link that is connected to a terminal or a failure has occurred in a terminal itself. An example of such a case will be described using FIG. 5.

FIG. 5 is an example of a failure in a network failure monitoring using the network tomography technique. In FIG. 5, the terminal 21f is a server and the terminal 21f is faulty. In this case, in network failure monitoring using the network tomography, the monitoring apparatus 24 cannot discriminate whether a failure has occurred in the link L10 or a failure has occurred in the terminal 21f.

As a result, the monitoring apparatus 24 according to the embodiment executes a process for specifying which of a link or a server a failure has occurred in, when a failure occurs in the link that is connected to the server. Here, in the case of a failure that occurs as a result of an overload of the server, there are characteristics in which the number of output packets is less than the number of numerous input packets. Therefore, if whether each terminal is a server or not is revealed, a server failure can be separated from a link failure by using the characteristics.

Therefore, in a process for specifying which of a link or a server a failure has occurred in, the monitoring apparatus 24 at first executes a server identification process for judging whether each terminal is a server or not.

The server identification process is executed on the basis of an amount of data that is input to and output from each terminal (input and output traffic amount). The server identification process is divided into two processes, i.e., a process based on the comparison between an input data amount and an output data amount of each terminal in a specified time period, and a process based on a correlation between communication data amounts of a plurality of terminals in a specified time period.

The server identification process based on the comparison between an input data amount and an output data amount is executed on a terminal whose amount of data that is input to and output from the terminal (communication data amount of the terminal) in a specified time period is a specified threshold value or greater. This is because when data amounts of comparison targets are small in the comparison of an input data amount and an output data amount, the result of a server specifying process might be incorrect. This is also because a data amount comparison cannot be made when there is no input data and output data in a specified time period.

The server identification process based on a correlation between communication data amounts is executed on a terminal whose communication data amount in a specified time period is less than a specified threshold value. This is because there are cases in which there is a correlation between communication data amounts of servers whose communication data amounts are small in consideration of characteristics of the servers.

As a server with a small communication data amount, there is a server to which, once the server is accessed, a next access is not performed until a time-out time comes. An example of such a server is an authentication server such as a DNS (Domain Name System) server or a RADIUS (remote Authentication Dial In User Service). Since both the DNS server and the authentication server are accessed when communication is generated, a correlation is generated in communication data amounts of the servers. For example, since a client accesses the DNS server once before it accesses the RADIUS server, and then accesses the RADIUS server, a correlation is generated between the number of input and output packets of the DNS server and the number of input and output packets of the RADIUS server. As described above, there are cases in which there is a correlation between communication data amounts of servers with small communication data amounts due to characteristics of the servers, and the server identification process based on the correlation between the communication data amounts is executed by using the characteristics.

The server identification process based on a correlation between communication data amounts is also executed on a terminal that is not judged to be a server or a client in the server identification process based on the comparison between an input data amount and an output data amount.

The server identification process based on the comparison between an input data amount and an output data amount is a process for comparing an input data amount and an output data amount of a terminal in a specified time period and identifying the terminal as a server when the output data amount is greater than the input data amount. This process uses characteristics of a server in which a data amount that is output to each client is greater than a data amount that is input from the client in a specified time.

For example, a comparison between an input data amount and an output data amount in each terminal is made for each flow of information that the terminal transmits and receives, and is made for all the flows of the terminal.

When the terminal is identified as a server, the comparison between an input data amount and an output data amount is made for a terminal that is logically connected to the terminal that is identified as a server (hereinafter merely referred to as a server). However, the comparison between an input data and an output data is made for the terminal that is logically connected to the server for each flow other than a flow in which a communication is performed with the server. When the output data amount is greater than the input data amount in all the flows except the flow in which communication is performed with the server, the terminal is identified as a server. Thus, when a terminal that is logically connected to a server is a server with respect to another terminal, the terminal logically connected to the server can be identified as a server.

Thus, terminals that are logically connected to a terminal that is identified as a server are serially tracked, and it is judged whether or not an output data amount is greater than an input data amount in each flow of the logically connected terminal with a terminal that is different from the server. Then, when the output data amount is greater that the input data amount in all the flows to a terminal that is different from a terminal that is specified as a server, it is judged that the terminal that is logically connected to the server is a server. The same process is repeated until there are no terminals to be searched for.

Specifically, a comparison between an input data amount and an output data amount is made by, for example, comparing the number of input packets and the number of output packets.

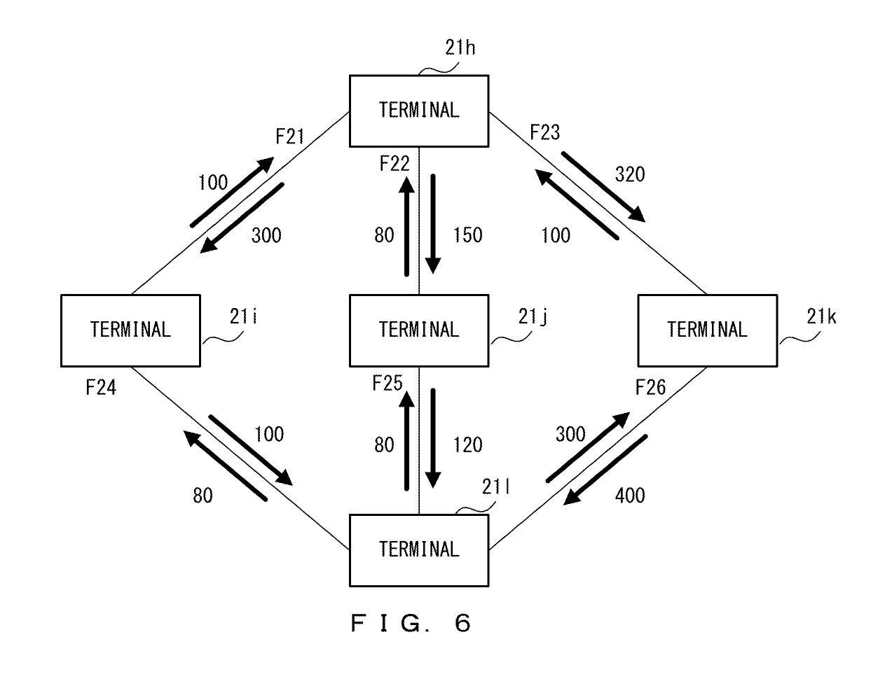

FIG. 6 is a diagram explaining the server identification process based on the comparison between an input amount and an output amount. In FIG. 6, flows among the terminals 21h to 21l and the number of packets that are transmitted and received in each flow are indicated.

At first, the monitoring apparatus 24 judges with respect to each monitoring target terminal whether or not the number of output packets is greater than the number of input packets in all the flows of each terminal. With respect to the terminal 21h in FIG. 6, in all of the flows (F21, F22 and F23) between the terminal 21h and the terminals 21i, 21j and 21k, the number of output packets is greater than the number of input packets. Therefore, in this case, the monitoring apparatus 24 judges that the number of output packets is greater than the number of input packets in all the flows of the terminal 21h, and as a result, identifies the terminal 21h as a server.

Next, the monitoring apparatus 24 judges whether or not the number of output packets is greater than the number of input packets with respect to each of the terminals 21i, 21j and 21k, which are logically connected to the terminal 21h, which is judged to be a server. Specifically, the monitoring apparatus 24 at first judges whether or not the number of output packets is greater than the number of input packets in all the flow (F24) between the terminal 21i and the terminal that is different from the terminal 21h, which is judged to be a server from among the flows (F21 and F24) of the terminal 21i. In the case of FIG. 6, since the number of input packets to the terminal 21i is 80 and the number of output packets from the terminal 21i is 100 in the flow F24, the monitoring apparatus 24 judges that the number of output packets is greater than the number of input packets, and as a result, identifies the terminal 21i as a server. With respect to the terminals 21j and 21k, in the same manner as in the case of the terminal 21i, the monitoring apparatus 24 judges whether or not the number of output packets is greater than the number of input packets. In the case of FIG. 6, the monitoring apparatus 24 identifies the terminals 21j and 21k as servers.

Next, in the same manner as in the case of the terminal 21i, etc., the monitoring apparatus 24 judges whether or not the number of output packets is greater than the number of input packets with respect to the terminal 21l, which is logically connected to the terminals 21i, 21j and 21k, which are judged to be servers. Since the terminal 21l is connected only to the terminals that are judged to be servers and is not logically connected to a terminal other than a server, the number of output packets is smaller than the number of input packets in all the flows of the terminal 21l. In this case, the monitoring apparatus 24 identifies the terminal 21l as a client (not a server).

The configuration of FIG. 6 is considered for example when the terminal 21h is a DB (DataBase) server, the terminals 21i, 21j and 21k are WEB/AP (Application) servers, and the terminal 21l is NAT (Network Address Translation) or a firewall. With respect to the number of input and output packets between the NAT or the firewall and the Web/AP server, the number of output packets from the Web/AP server is greater than the number of input packets to the Web/AP server. With respect to the relationship between the Web/AP server and the DB server in the number of input and output packets, the number of output packets from the DB server is greater than the number of input packets to the DB server. A server such as the DB server, which has the highest order in a hierarchy system and in which the number of output packets is greater than the number of input packets in all the flows, is specified at first, and terminals under it are sequentially searched for, so that identification for whether it is a server or not can be performed on all the terminals. Although the number of output packets is greater than the number of input packets in a flow to (the NAT or firewall) other than a flow to a host server (DB server), such a terminal can be identified as a server in the embodiment.

The server identification process based on a correlation between communication data amounts is a process for judging whether or not there is a correlation between communication amounts of terminals for a specified time period, and identifying as servers terminals in which there is a correlation between their communication amounts. The communication amount refers to one of an input data amount and an output amount, or the sum of both.

Specifically, the monitoring apparatus 24 acquires information on the number of input packets that is measured at a specified interval for a specified time period in each flow of an identification target terminal. The monitoring apparatus 24 can acquire information on a change in the number of input packets in a time series from the information on the number of input packets that is measured at the specified interval in the specified time period. Next, the monitoring apparatus 24 calculates a threshold value on the basis of an average value and a variance in the number of input packets in the specified time period. Then, the monitoring apparatus 24 specifies a time at which the number of input packets exceeds the calculated threshold value and the number of input packets becomes maximal. As described above, the monitoring apparatus 24 specifies the time at which the number of input packets becomes maximal with respect to all the flows of a plurality of terminals. The monitoring apparatus 24 judges whether or not there are terminals that have the same time as the maximal value that is specified in the specified time period among the plurality of terminals. Then, the monitoring apparatus 24 judges as servers the terminals that have the same time as the maximal value in the specified time period. The monitoring apparatus 24 may set the number of maximal values as a comparison target in addition to the time for the maximal value.

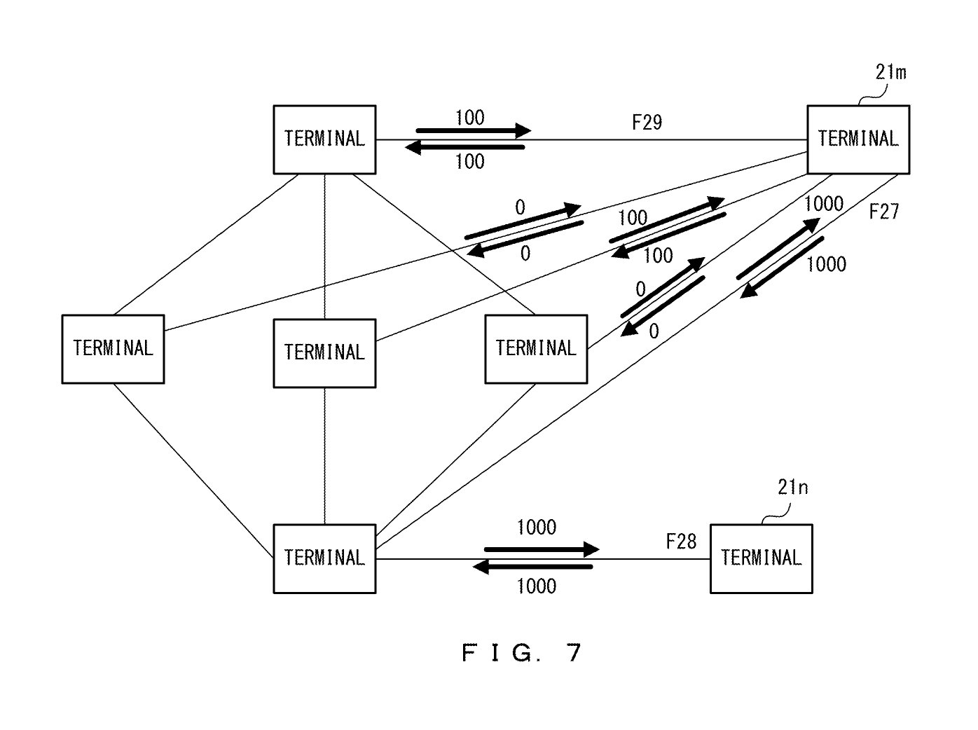

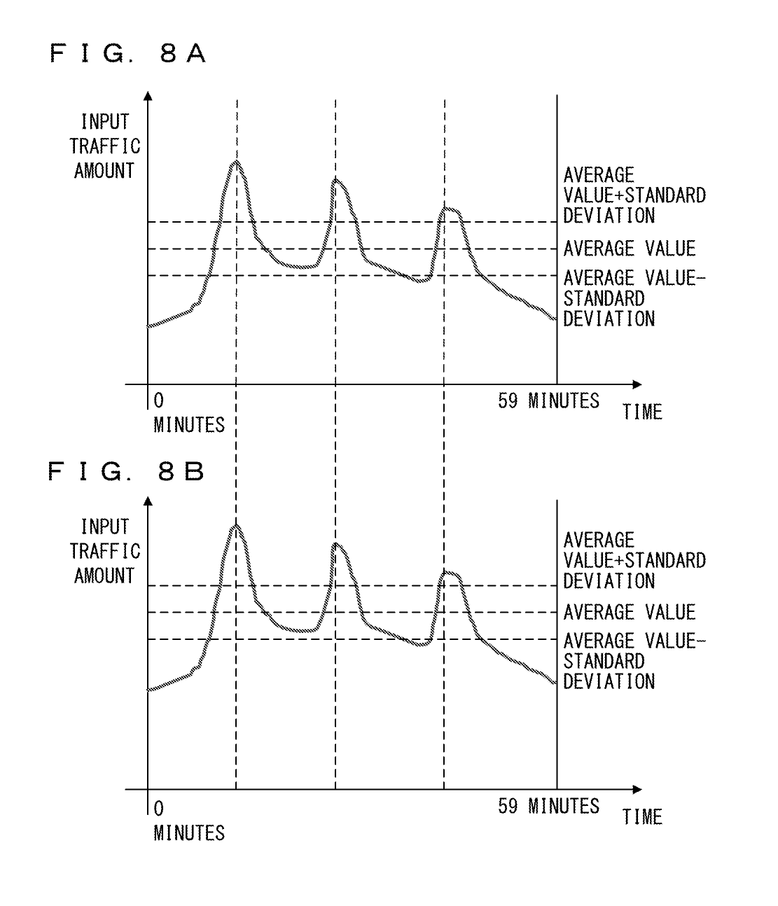

FIGS. 7, 8A and 8B are diagrams for explaining a server specifying process based on a correlation between communication data amounts in a specified time period. FIG. 7 indicates a flow of the terminal 21m, a flow of the terminal 21n, and the number of packets that are transmitted and received in each flow. FIG. 8A illustrate a time-series change in the number of packets that are input to the terminal 21m in the flow (F27) of the terminal 21m. FIG. 8B illustrate a time-series change in the number of packets that are input to the terminal 21n in the flow (F28) of the terminal 21n. In FIGS. 8A and 8B, changes in the number of input packets over 1 hour is illustrated. At that time, the monitoring apparatus 24 calculates an average value and a standard deviation in the number of input packets over one hour, and sets the sum of the average value and the standard deviation as a threshold value. In FIGS. 8A and 8B, the monitoring apparatus 24 judges whether all the times of the maximal values that exceed the calculated sum of the average value and the standard deviation agree with each other. In the case of FIGS. 8A and 8B, the monitoring apparatus 24 judges that all the times of the maximal values that exceed the sum of the average value and the standard deviation agree with each other, and judges that the terminal 21m and the terminal 21n are servers.

As a result, an identification process as to whether a terminal is a server or not is made possible for a terminal with a small communication data amount. Since there are cases in which a time-out value is different in each server, when any of the maximal values of the communication data amount of one terminal agrees with all the maximal values of the communication data amount of the other terminal, these terminals may be judged to be servers. In addition, when a time for the maximal value has a specified duration and all of the times of the maximal values that are comparison targets are included in the specified duration, it may be judged that the times of the maximal values that are comparison targets agree with each other.

A correlation between communication data amounts in a specified time period may be calculated by various methods, such as a method for judging whether or not there is a correlation by using a correlation coefficient. In the embodiment, the phrase “there is a correlation” refers to a case in which times at which maximal values that exceed a variance value of each flow of each terminal are generated agree with each other or the number of generated maximal values of a flow of one terminal agrees with the number of generated maximal values of a flow of another terminal, but is not limited to this.

The configuration of FIG. 7 is considered, for example, when the terminal 21m is a DNS server and the terminal 21n is a RADIUS server.

When there is a terminal for which a server cannot be specified in the server specifying process based on the amount of data that is input and output to and from each terminal in a specified time period, the monitoring apparatus 24 can execute a server identification process in the same manner for a longer time period (for example, 12 hours or one day).

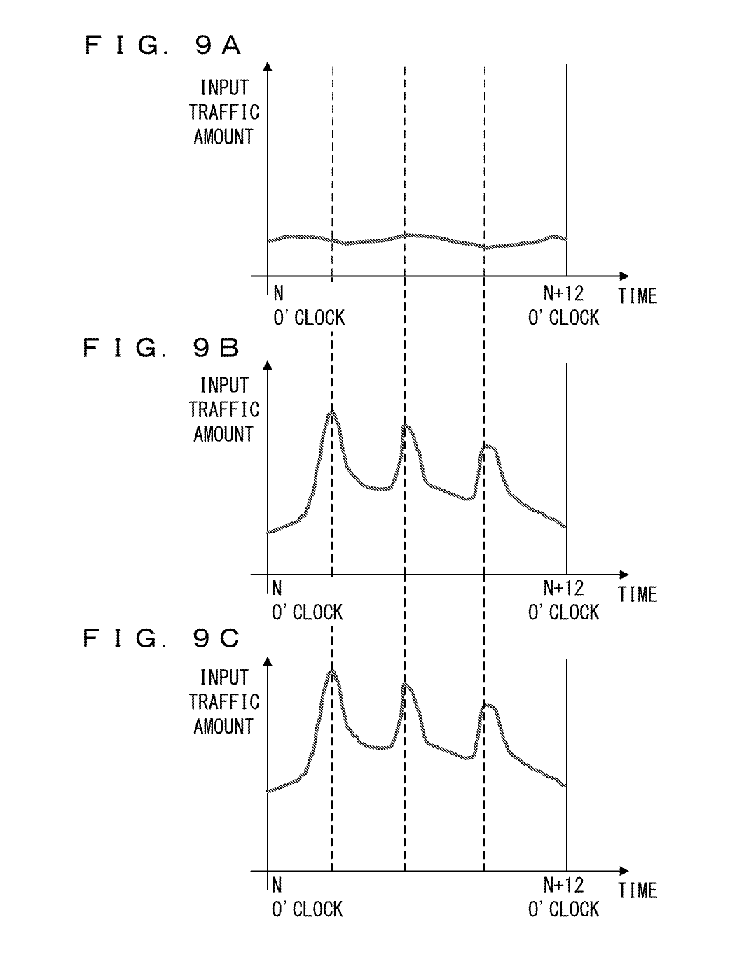

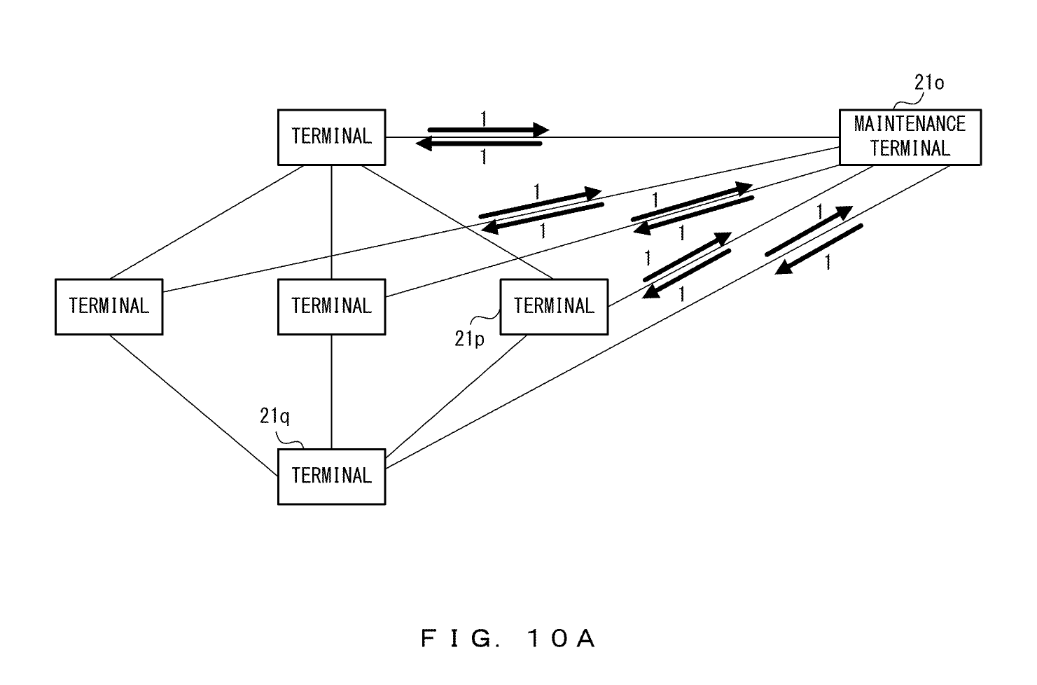

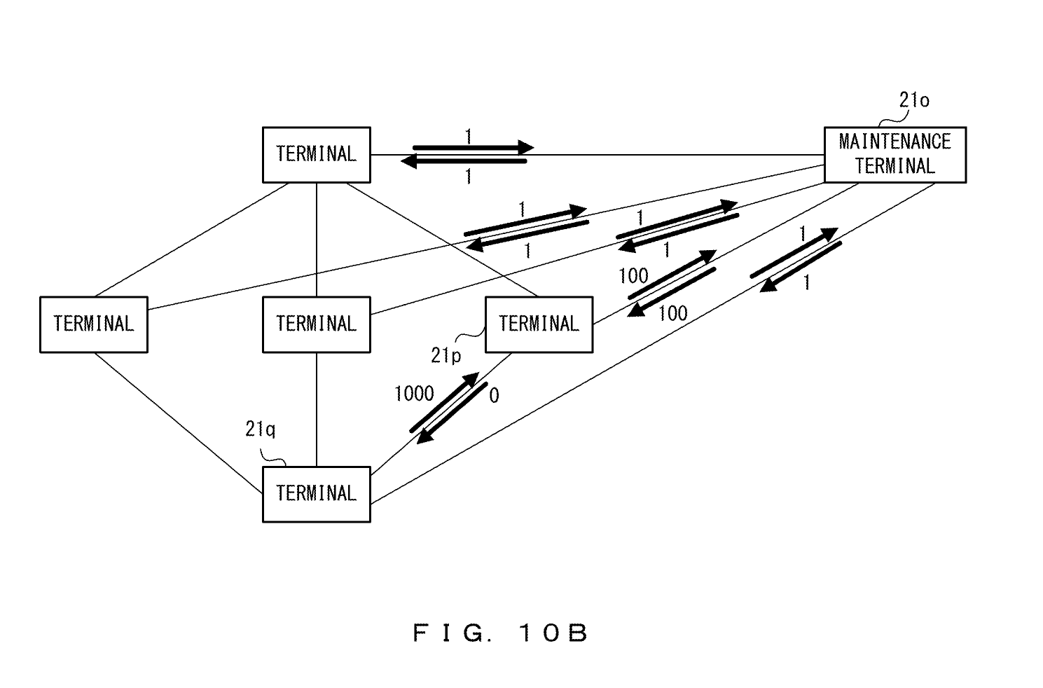

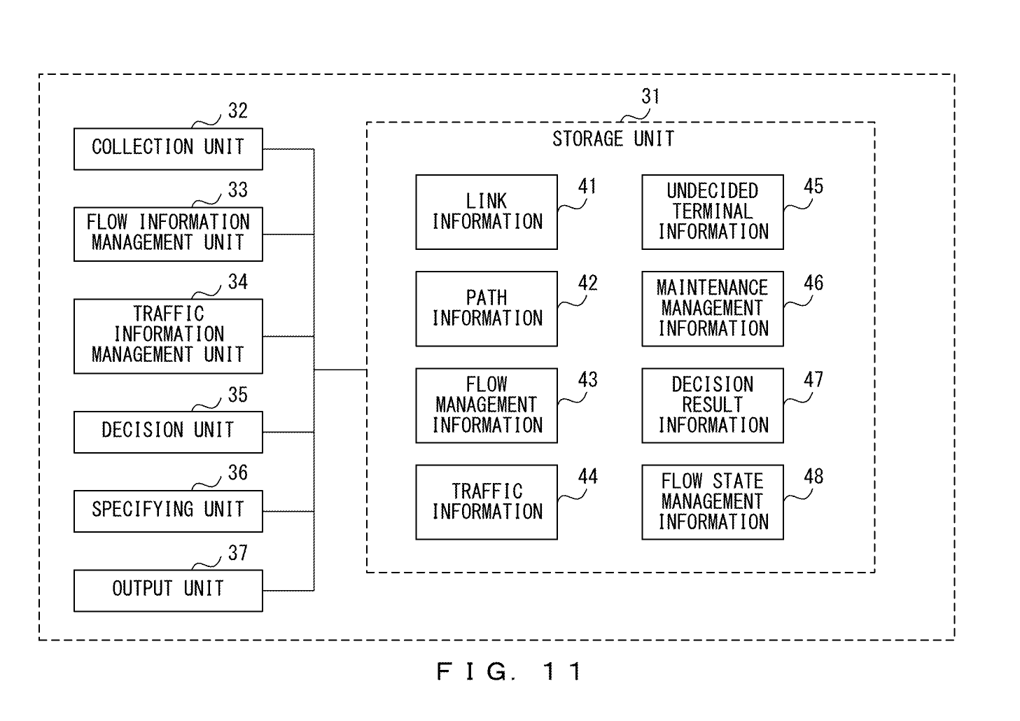

FIGS. 9A, 9B, and 9C illustrate one example of a change in an input data amount of a terminal that is used in a server specifying process based on a communication data amount for a long time period. FIGS. 9A, 9B, and 9C illustrate changes for 12 hours in the number of input packets to the terminal 21m of the flow F29, the number of input packets to the terminal 21m of the flow F27, and the number of input packets to the terminal 21n of the flow F28 in FIG. 7, respectively. Thus, the server specifying process may be executed on the basis of the data amount for a long time period that is input and output to and from each terminal. Times of the maximal values in FIG. 9A and FIG. 9C do not agree with each other, but times of the maximal values in FIG. 9B and FIG. 9C do agree with each other. As described above, when the maximal value of any flow of the terminal 21m and the maximal value of any flow of the terminal 21n agree with each other, the monitoring apparatus 24 judges that the terminal 21m and the terminal 21n are servers.

The monitoring apparatus 24 executes a failure specifying process in the middle of a server identification process or when the identification process is terminated. The failure specifying process is divided into a failure specifying process using network tomography and a failure specifying process based on a communication data amount of a terminal.

In the failure specifying process using the network tomography, the monitoring apparatus 24 at first performs the network failure monitoring using the network tomography technique, which was described with reference to FIGS. 3-5. When the monitoring apparatus 24 judges that a failure has occurred in a link that is included in the network 20 as a result of the network failure monitoring using the network tomography technique, the monitoring apparatus 24 judges whether or not the link in which it is judged that a failure has occurred is a link that is connected to a server. When the monitoring apparatus 24 judges that the link in which it is judged that the failure has occurred is the link that is connected to the server, the monitoring apparatus 24 compares an input data amount and an output data amount to and from the server to which the faulty link is connected. When the monitoring apparatus 24 judges that the input data amount is greater than the output data amount, the monitoring apparatus 24 judges that the failure has occurred in the server.

In the failure specifying process based on communication data amounts, a failure decision is made for a target terminal on the basis of a change (increasing and decreasing) in a data amount that is communicated between the failure decision target terminal and a maintenance terminal, and a communication data amount of the target terminal.

The network 20 might include a maintenance terminal that periodically performs life-and-death monitoring on nodes that are periodically managed by a maintenance person. The maintenance terminal periodically performs polling on a maintenance target terminal. The data amount that is communicated between the maintenance terminal and each maintenance target terminal is constant within a specified range when a failure does not occur in the maintenance target terminal; however, when a failure occurs in the maintenance target terminal, the data amount that is communicated between the terminal in which a failure has occurred and the maintenance terminal increases. For such a case, a case is considered wherein when a failure occurs in any server, the server is investigated due to a claim etc. from a user, so that the number of input and output packets to and from the server increases. In addition, a terminal in which a failure has occurred cannot transmit data to a terminal that is different from the maintenance terminal. That is, in a flow to a terminal in which a failure has occurred, a data amount that is output from the terminal in which the failure has occurred to a terminal that is different from the maintenance terminal is 0.

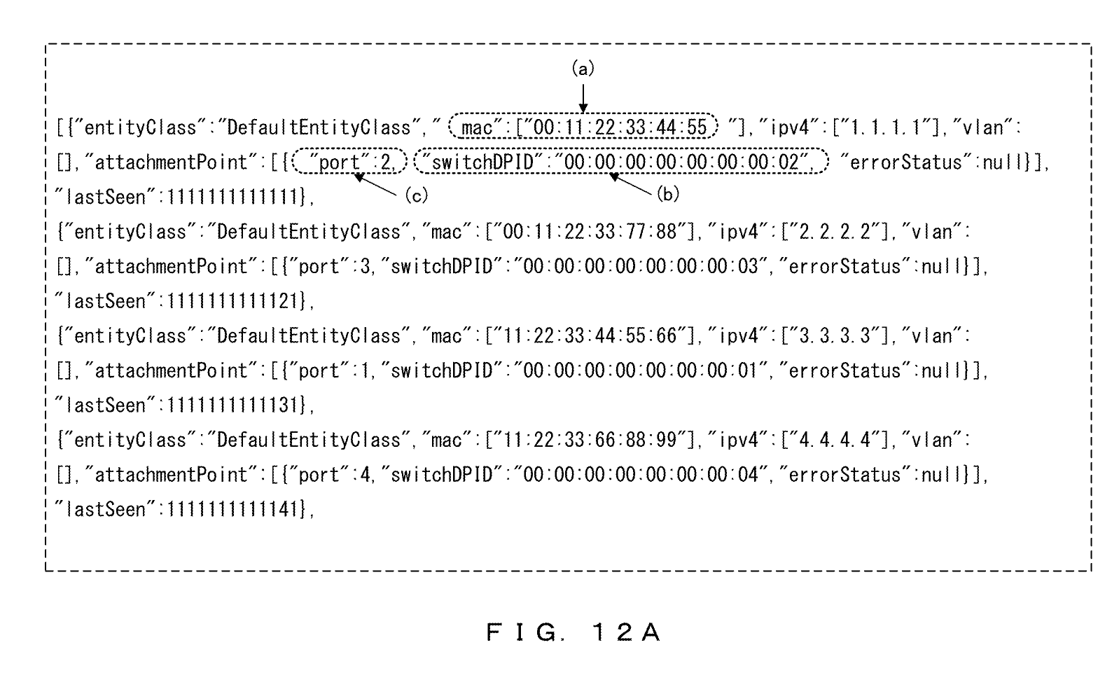

FIGS. 10A and 10B are diagrams explaining a change in a communication data amount between a maintenance target terminal and a maintenance terminal when a failure occurs.

FIG. 10A illustrates monitoring in a case in which all of the maintenance target terminals are normal, and FIG. 10B illustrates monitoring in a case in which a failure has occurred in a maintenance target terminal. In FIG. 10A, the maintenance terminal 210 performs life-and-death monitoring based on polling on a plurality of terminals, and the number of packets that is communicated between each terminal and the maintenance terminal is “1”. FIG. 10B is an example of monitoring in a case in which a failure has occurred in a terminal. In this case, the communication data amount between the maintenance terminal 21o and the terminal 21p in which a failure has occurred increases to “100”. The data amount that is output from the terminal 21p to the terminal 21q that is different from the maintenance terminal 210 is “0”.

In consideration of the above, the monitoring apparatus 24 specifies a terminal whose data amount (traffic amount) that is communicated between the terminal and the maintenance terminal is greater than a specified threshold value in a specified time period. Then, the monitoring apparatus 24 judges whether or not there is no output data even though there is input data to the specified terminal in all the flows of information that is communicated between the specified terminal and a terminal that is different from the maintenance terminal. When the monitoring apparatus 24 judges that there is no output data even though there is input data, the monitoring apparatus 24 judges that a failure has occurred in the specified terminal.

Since the failure specifying process based on input and output data amounts as described above is under a provision that a maintenance person accesses a server whose behavior is abnormal and investigates it, an abnormal server can be specified by performing such a process.

When a failure occurs in a terminal, there are cases in which a transmission data amount from the terminal to the maintenance terminal is 0, but a transmission data amount from the maintenance terminal to the terminal in which the failure has occurred also increases in this case. As a result, operations of the monitoring apparatus 24 in the failure specifying process are the same as in the case in which there is a data amount from a terminal in which a failure has occurred to the maintenance terminal.

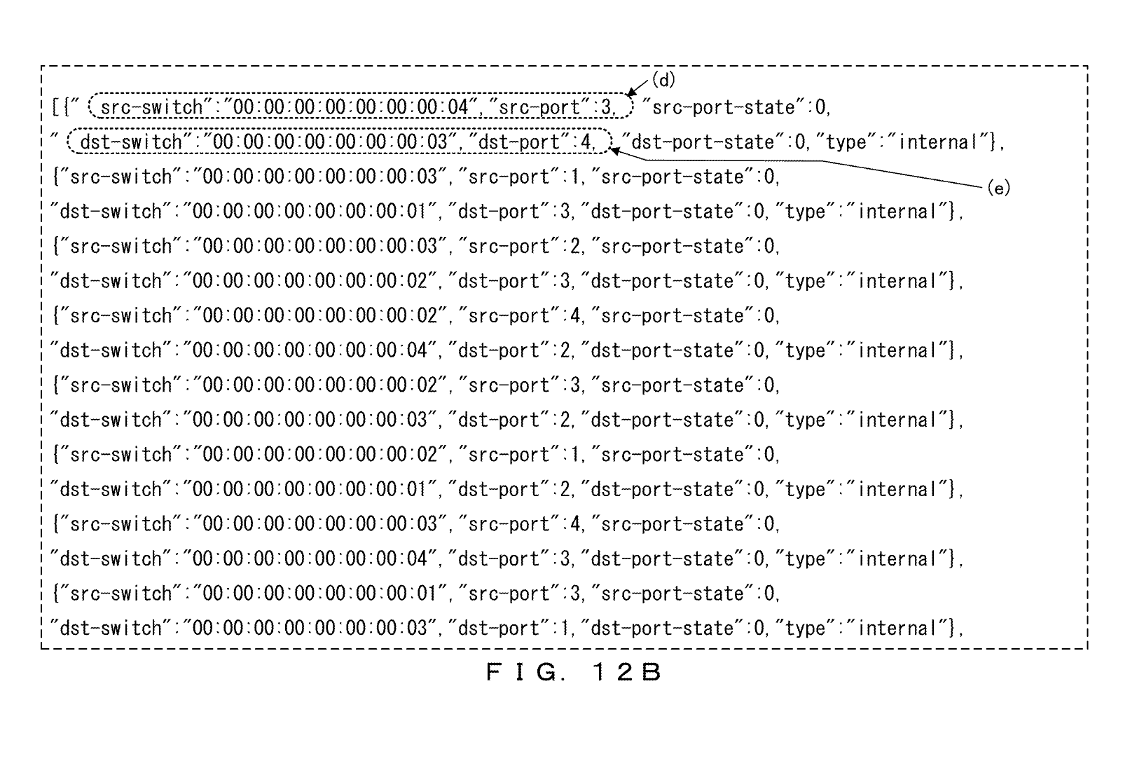

Next, the configuration of the monitoring apparatus 24 will be described. FIG. 11 illustrates an example of the configuration of the monitoring apparatus 24. In FIG. 11, the monitoring apparatus 24 includes a storage unit 31, a collection unit 32, a flow information management unit 33, a traffic information management unit 34, a decision unit 35, a specifying unit 36, and an output unit 37.

The collection unit 32 is an example of the acquisition unit 1. The flow information management unit 33, the traffic information management unit 34, and the decision unit 35 are an example of the identification unit 2. The specifying unit 36 is an example of the failure decision unit 3.

The storage unit 31 includes link information 41, path information 42, flow management information 43, traffic information 44, undetermined terminal information 45, maintenance management information 46, decision result information 47, and flow-state management information 48. Details of each piece of information will be described in detail hereinafter.

The collection unit 32 collects topology information and flow information from the controller 22 at a fixed time period. Then, the collection unit 32 outputs the topology information and the flow information to the flow information management unit 33, the traffic information management unit 34, and the specifying unit 36.

The topology information includes link information 41 between switches. Specifically, the topology information includes identification information of a terminal and identification information and a port number of a relay apparatus that is connected to the terminal. The topology information also includes identification information and port numbers of relay apparatuses that are interconnected. The flow information includes statistical information with respect to each flow. Specifically, the flow information includes identification information of two terminals that communicate with each other in a flow, and information that indicates an amount of data that is communicated in the flow.

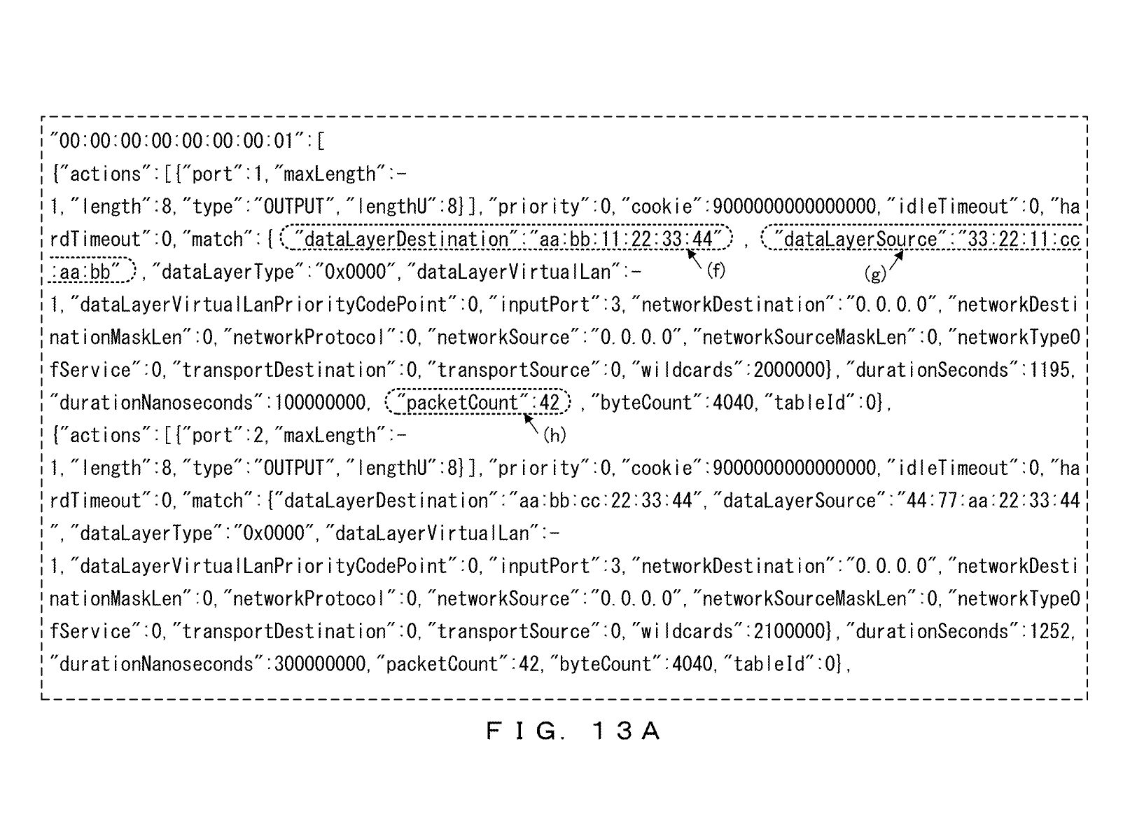

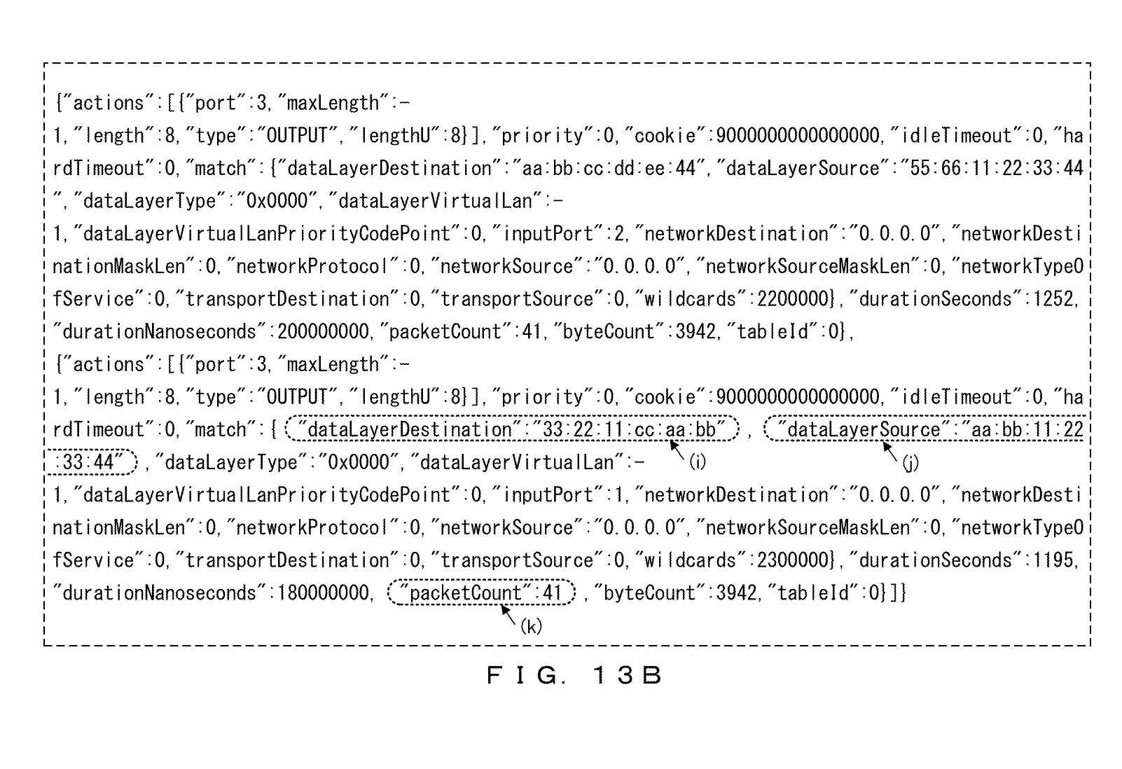

FIGS. 12A and 12B are an example of topology information. As illustrated in FIG. 12A, the topology information includes connection information of a terminal and a switch. In FIG. 12A, specifically, (a) indicates a MAC address (Media Access Control address) of the terminal, (b) indicates identification information of the switch, and (c) indicates a port number of the switch (b) that is connected to the terminal (a). The topology information includes connection information between switches as illustrated in FIG. 12B. In FIG. 12B, specifically in (d) and (e), identification information and a port number of each of the two switches to be connected with each other are indicated.

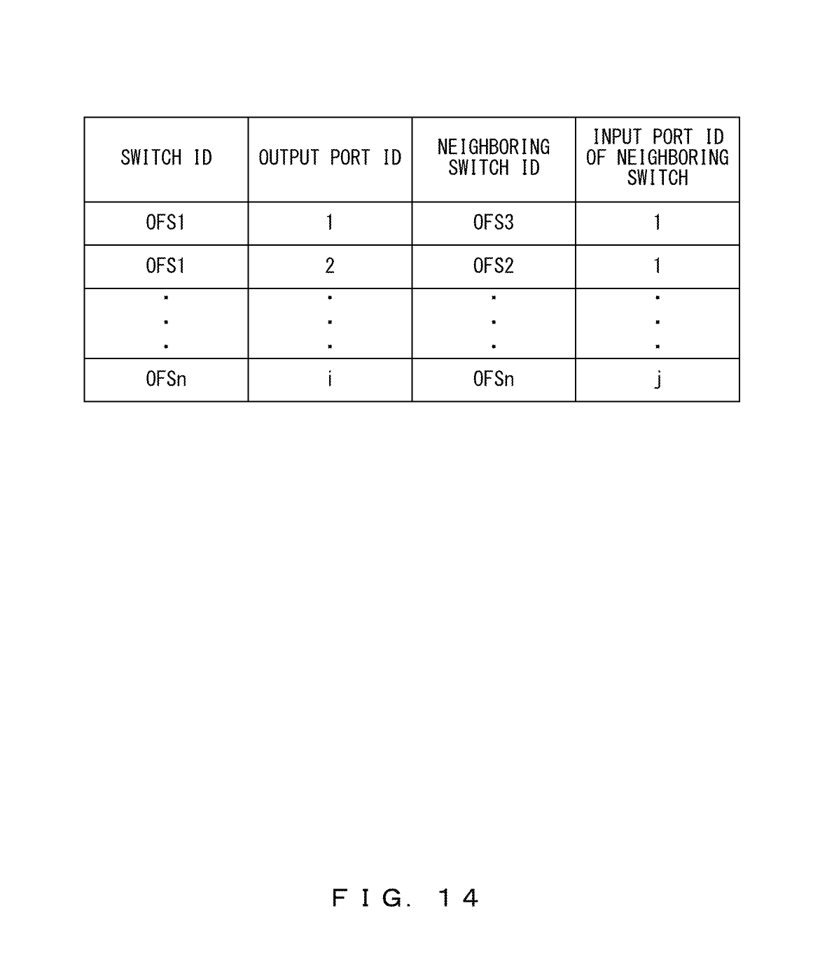

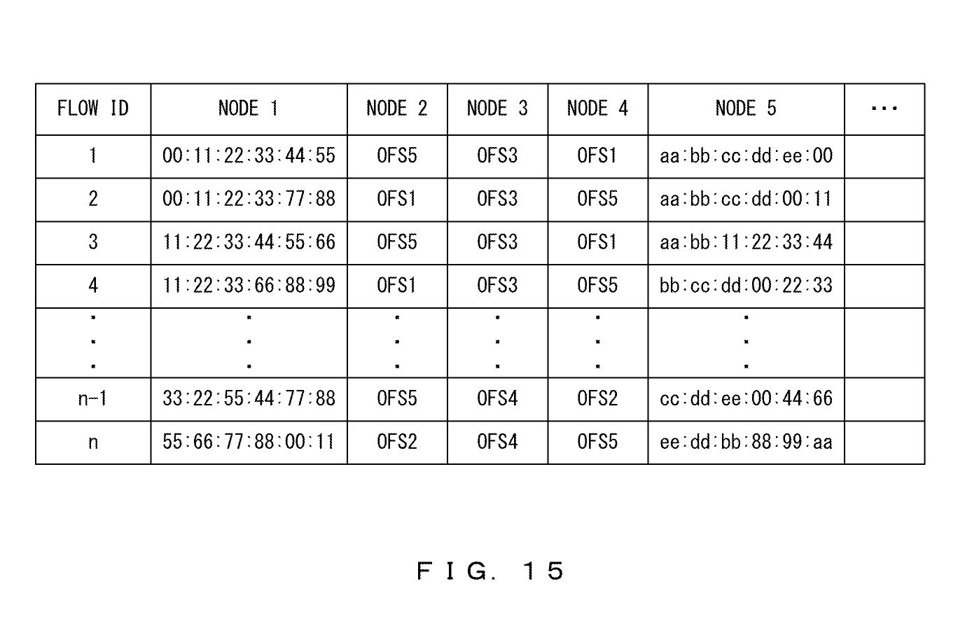

FIGS. 13A and 13B are an example of the flow information. In FIGS. 13A and 13B, the flow information indicates, in (f) and (g), each MAC address of two terminals that are communicated in a flow. In (h), the number of packets that are communicated in the flow is indicated. In addition, the flow information of (i) and (j) in which the transmission source and destination of (f) and (g) are switched are indicated. In (k), the number of packets that are communicated in the flows of (i) and (j) is indicated.

The flow information management unit 33 generates link information 41, path information 42, and flow management information 43 from topology information and flow information that are input from the collection unit 32.

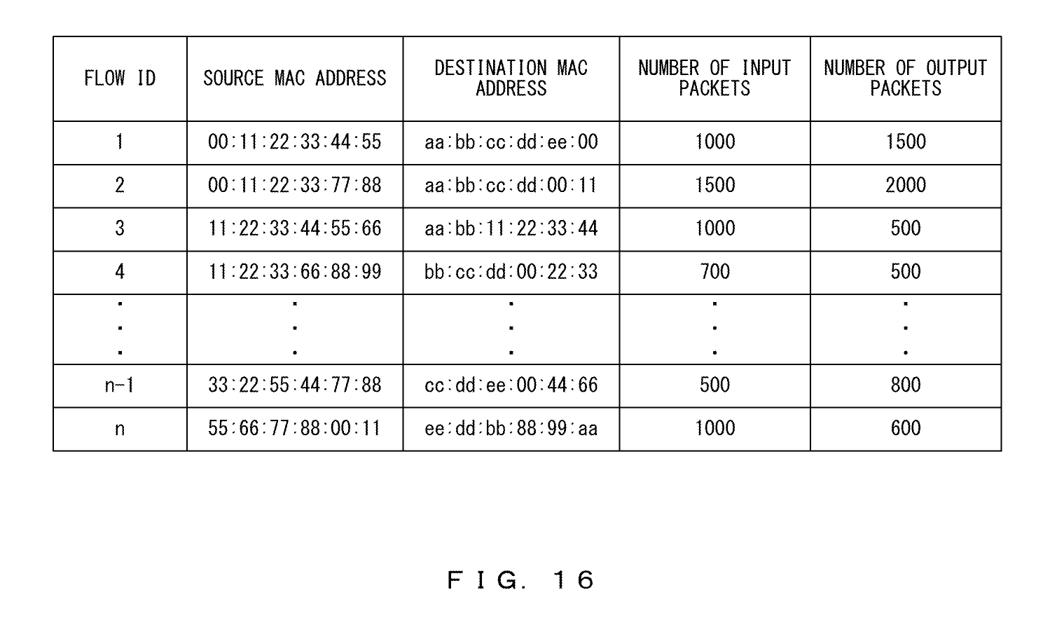

The link information 41 is information that indicates a connection relationship between relay apparatuses. The link information 41 is used in a network tomography process. FIG. 14 illustrates an example of the link information 41. The link information 41 stores data items, a “switch ID”, an “output port ID”, a “neighboring switch ID”, and a “neighboring switch input port ID” in association with one another. The “switch ID” indicates identification information for uniquely identifying a relay apparatus. The “output port ID” indicates identification information for uniquely identifying the output port of the relay apparatus of the corresponding “switch ID”. The “neighboring switch ID” indicates identification information of the relay apparatus that is connected to the port of the “output port ID” of the relay apparatus of the corresponding “switch ID.” The “neighboring switch input port ID” indicates identification information for uniquely identifying the input port of the relay apparatus that is connected to the port of the “output port ID” of the relay apparatus of the corresponding “switch ID.” This link information 41 enables the monitoring apparatus 24 to grasp which path a flow between terminals physically passes through.

The path information 42 indicates which relay apparatus and in which order information that is communicated between two terminals in each flow is routed. That is, the path information 42 is information in which each flow, identification information of a terminal which communicates in a flow, and identification information of a relay apparatus by which information that is communicated between terminals in a flow is relayed, are associated with one another in the order in which information is communicated.

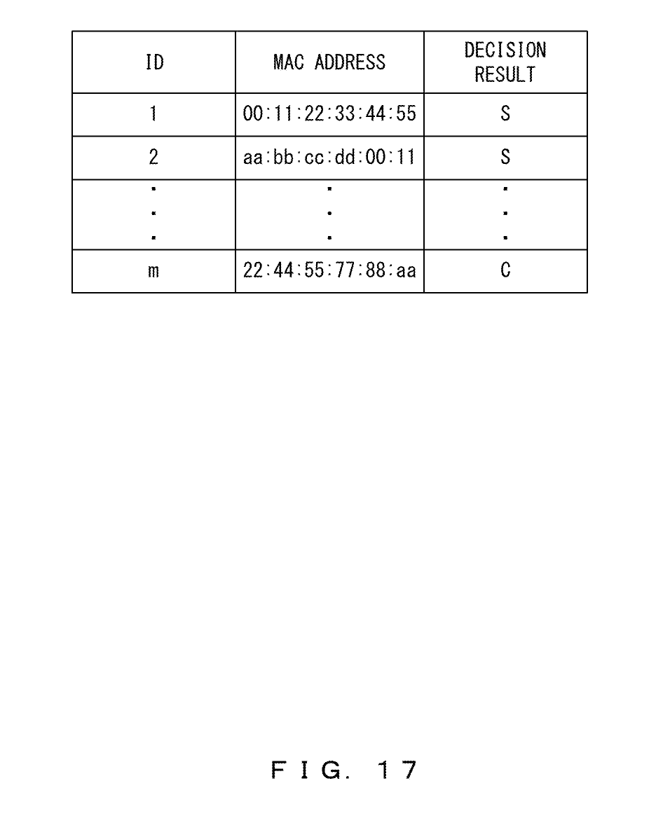

FIG. 15 illustrates an example of the path information 42. In FIG. 15, the path information 42 includes data items, a “flow ID” and a “node.” The “flow ID” is identification information for uniquely identifying a flow. The “node” includes data items, “node 1”, “node 2” . . . “node N.” “Node 1” indicates identification information of one of two end terminals in the flow of the corresponding “flow ID”. “Node 2” indicates identification information of a relay apparatus or a terminal to which information that is communicated in the flow of the corresponding “flow ID” is directly communicated from the corresponding “node 1” terminal without going via another relay apparatus. “Node N” indicates identification information of a relay apparatus or a terminal to which information that is communicated in the flow of the corresponding “flow ID” is directly communicated from the corresponding “node N−1” relay apparatus without going via another relay apparatus. The “node” in FIG. 15 includes two terminals between which information is communicated and a relay apparatus by which information that is communicated between the two terminals is relayed. The “node” includes information that indicates the order of the node to which information that is transmitted in one direction in a flow is conveyed. The number of data items of the “node” changes for each flow according to the number of relay apparatuses by which information that is communicated in a flow is relayed.

For example, FIG. 15 illustrates that the flow that is indicated as the flow ID “1” is transmitted to and received by the terminal “aa:bb:cc:dd:ee:00” from the terminal “00:11:22:33:44:55” via (is relayed by) the switches “OFS5”, “OFS3”, and “OFS1”. In FIG. 15, in the sequence of node identification information, first and last pieces are terminals. In FIG. 15, terminal identification information is indicated as a MAC address, and switch identification information is indicated as a switch ID.

Use of the path information 42 enables the monitoring apparatus 24 to specify a faulty portion by using network tomography.

The flow management information 43 stores in association with each other the MAC address of a data transmission and reception terminal and the number of input and output packets with respect to a communication of each flow that is generated within a specified measurement interval (for example, one minute). For the number of input and output packets, the minimum value of the traffic amount of the flow information of each switch with respect to the same flow or the number of packets of a link to which the terminal is connected is used. By using the flow management information 43, the monitoring apparatus 24 can perform the server identification process based on the comparison between the number of input packets and the number of output packets.

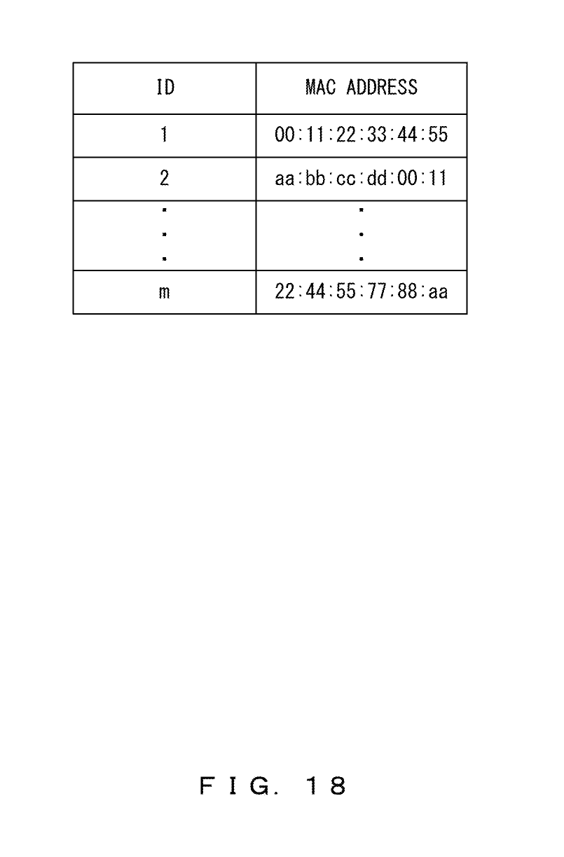

FIG. 16 illustrates an example of the flow management information 43. The flow management information 43 stores data items, a “flow ID”, a “source MAC address”, a “destination MAC address”, “the number of input packets”, and “the number of output packets” in association with one another.

The “flow ID” indicates identification information for uniquely identifying a flow. The “source MAC address” indicates the MAC address of one of the terminals between which information is communicated in the flow of the corresponding “flow ID”. The “destination MAC address” indicates the MAC address of the terminal that communicates information with the terminal of the “source MAC address” in the flow of the “flow ID”. “The number of input packets” indicates the number of packets that are input from the terminal of the “source MAC address” to the terminal of the “destination MAC address” per unit time (measurement interval) in the flow of the “flow ID”. “The number of output packets” indicates the number of packets that are output from the terminal of the “destination MAC address” to the terminal of the “source MAC address” per unit time (measurement interval) in the flow of the “flow ID”.

The decision unit 35 judges whether or not each terminal is a server on the basis of the number of input and output packets of each terminal in a specified time period. With respect to the terminal whose number of input and output packets in the specified time period is less than a specified threshold value, the decision unit 35 judges whether or not the terminal is a server on the basis of a correlation of the number of input packets in the specified time period with another terminal.

At first, the server identification process based on the number of input and output packets of a terminal in a specified time period will be described. The decision unit 35 judges whether or not the number of output packets from an identification target terminal is greater than the number of input packets to the target terminal in all the flows in which information is communicated to the target terminal. Then, the decision unit 35 judges that the target terminal is a server when it judges that the number of output packets is greater that the number of input packets. However, when the number of input and output packets is smaller than a specified threshold value, the server specifying process that uses the number of input and output packets is not performed. Then, the decision unit 35 stores identification information of the server that is judged to be a server and information that indicates that the server is judged to be a server on the decision result information 47 in association with each other.

In the server identification process based on the number of input and output packets, the decision unit 35 specifically focuses on one terminal among identification target terminals. Here, a focused-on terminal is referred to as a target terminal.

Then, the decision unit 35 at first extracts all the rows in which the “destination MAC address” is same as the MAC address of the target terminal in flow information. Next, the decision unit 35 compares the value of “the number of input packets” and the value of “the number of output packets” of the extracted rows. When the decision unit 35 judges that the value of “the number of output packets” is greater than the value of “the number of input packets” in all the extracted rows, then the decision unit 35 extracts all the rows in which the “source MAC address” agrees with the MAC address of the target terminal. Then, the decision unit 35 compares the value of “the number of input packets” and the value of “the number of output packets” of the extracted rows. When the value of “the number of input packets” is greater than the value of “the number of output packets” in all the extracted rows, the decision unit 35 judges that the target terminal is a server.

Similarly, the decision unit 35 performs a process for identifying whether or not a target terminal is a server by setting all the terminals of the identification target terminals as the target terminals.

Hereinafter, a terminal that is judged to be a server by the decision unit 35 is referred to merely as a server.

Next, the decision unit 35 judges to be a server a terminal that is logically connected to a server, when the number of output packets of each flow that is different from the flow in which information is communicated with the server is greater than the number of input packets of each flow in the terminal that is logically connected to the server.

Specifically, the decision unit 35 at first specifies the terminal that is logically connected to a server. This specifying process is performed by using the flow management information 43 or the path information 42. For example, when the terminal is specified by using the flow management information 43, the decision unit 35 at first extracts the row in which the “destination MAC address” agrees with the MAC address of the server, and acquires the value of the “source MAC address” of the extracted row. The decision unit 35 at first specifies the terminal of the “source MAC address” that is acquired in this manner as the terminal that is logically connected to the server. In addition, the management unit 35 extracts the row in which the “source MAC address” agrees with the MAC address of the server, and acquires the value of the “destination MAC address” of the extracted row. The decision unit 35 specifies the terminal of the “destination MAC address” that is acquired in this manner as the terminal that is logically connected to the server.

The decision unit 35 focuses on one terminal from among the specified terminals that are logically connected to the server. Here, the terminal that is focused on is referred to as a focused-on terminal. Next, the decision unit 35 at first extracts all the rows in which the “destination MAC address” is the same as the MAC address of the focused-on terminal and the value of the “source MAC address” is different from the MAC address of the server. Then, the decision unit 35 compares the value of “the number of output packets” and the value of “the number of input packets” in the extracted rows.

When the decision unit 35 judges that the value of “the number of output packets” is not greater than the value of “the number of input packets” in any of the extracted rows, the decision unit 35 judges that the focused-on terminal is a client. On the other hand, when the decision unit 35 judges that the value of “the number of output packets” is greater than the value of “the number of input packets” in all the extracted rows, the decision unit 35 executes the following process. That is, the decision unit 35 extracts all the rows in which the “source MAC address” is the same as the MAC address of the focused-on address, and the “destination MAC address” is different from the MAC address of the server. Then, the decision unit 35 compares the value of “the number of input packets” and the value of “the number of output packets” of the extracted rows.

When the value of “the number of input packets” is greater than the value of “the number of output packets” in all the extracted rows, the decision unit 35 judges that the focused-on terminal is a server. On the other hand, when the value of “the number of input packets” is not greater than the value of “the number of output packets” in any of the extracted rows, the decision unit 35 judges that the focused-on terminal is a client.

Similarly, the decision unit 35 executes a process for judging whether a focused-on terminal is a server or a client by setting, as focused-on terminals, all the terminals that are logically connected to a server. When it is judged that the focused-on terminal is a server, the decision unit 35 further makes a decision as to whether or not it is a server for all the terminals that are connected to the focused-on terminal with a logical link and that are different from a server.

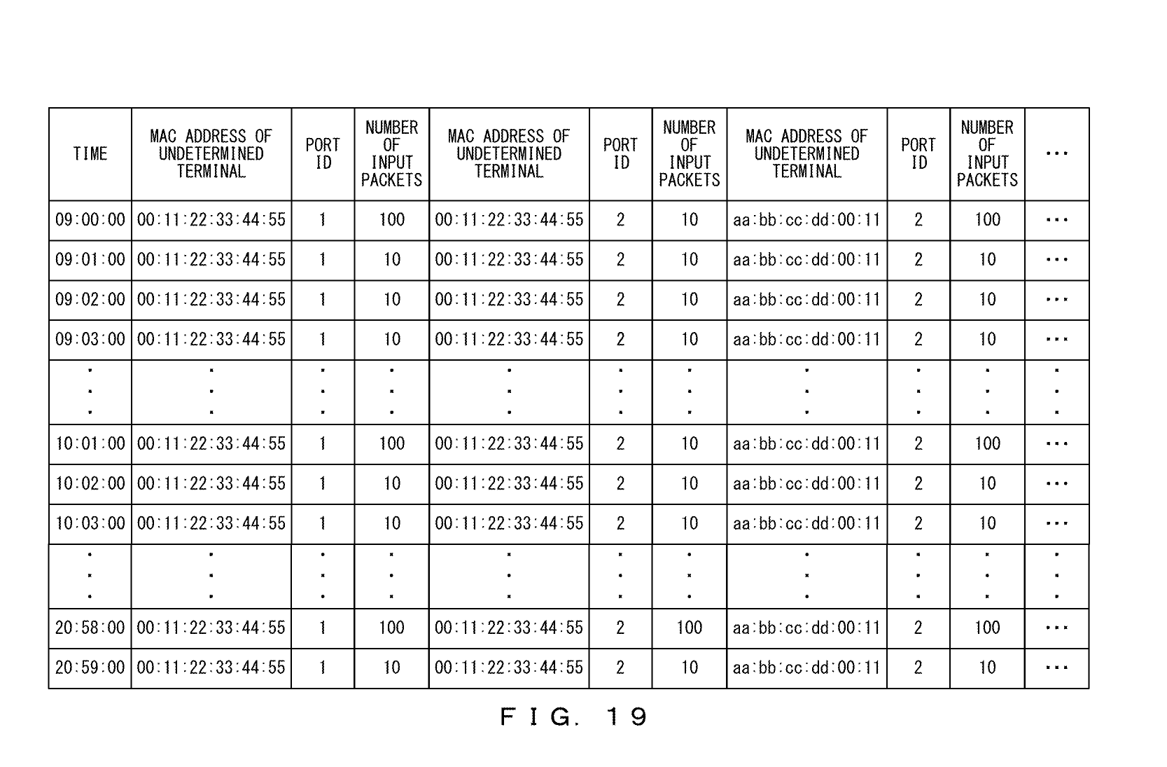

As described above, the decision unit 35 executes the server identification process based on the comparison result of input and output data amounts, and records the result on decision result information 47. The decision result information 47 stores the identification information and the decision result of a terminal in association with each other. FIG. 17 illustrates an example of the decision result information 47. In FIG. 17, the decision result information 47 stores data items, an “ID”, a “MAC address”, and a “decision result” in association with one another. The “ID” is a management number for managing decision result information 47. The “MAC address” is the MAC address of a terminal. The “Decision result” is the decision result of the terminal of the corresponding the “MAC address”, and indicates whether the terminal is a server or a client. In the example of FIG. 17, in the “decision result”, “S” indicates that the terminal is a server, and “C” indicates that the terminal is a client (not a server).

Next, a server identification process will be described, the server identification process being directed to the terminal in which it is judged that the number of input and output packets is smaller than a specified threshold value in the identification process based on the number of input and output packets, and to the terminal that is judged to be neither a server nor a client in the identification process based on the number of input and output packets. Hereinafter, the terminal in which it is judged that the number of input and output packets in the specified time period is smaller than the specified threshold value and the terminal that is judged to be neither a server nor a client in the identification process based on the number of input and output packets are referred to as undetermined terminals TG1.

The decision unit 35 records the identification information on the undetermined terminal TG1 in the undetermined terminal information 45, and manages the identification information. FIG. 18 illustrates an example of the undetermined terminal information 45. The undetermined terminal information 45 stores data items, a “MAC address”, and an “ID” in association with each other. The “ID” is a management number for managing the undetermined terminal information 45. The “MAC address” is the MAC address of the undetermined terminal.

The decision unit 35 executes the server identification process based on a correlation between communication data amounts of the terminals with respect to the undetermined terminal TG1. Traffic information 44 is used in the server identification process based on a correlation between communication data amounts. The traffic information 44 is managed by the traffic information management unit 34.

The traffic information management unit 34 generates the traffic information 44 from topology information and flow information that are input from the collection unit 32. The traffic information 44 is information that indicates the number of input packets of each undetermined terminal TG1 for each specified measurement interval in a specified time period.

FIG. 19 is an example of the traffic information 44. In FIG. 19, the traffic information 44 stores a data item, a “time” and a combination of data items, a “MAC address of the undetermined terminal”, a “port ID”, and “the number of input packets” in association with each other.

The “time” indicates a time of a specified time interval. The combination of the three data items, the “MAC address of the undetermined terminal”, the “port ID”, and “the number of input packets” collectively indicate information on one undetermined terminal. As many of the combinations of the three data items as the number of undetermined terminals TG1 are stored in each row. The “MAC address of the undetermined terminal” indicates the MAC address of the undetermined terminal TG1. The “port ID” indicates the port number of the terminal of the corresponding “MAC address”. “The number of input packets” indicates the number of packets that are input to the port of the “port ID” of the terminal of the corresponding “MAC address” from the “time” of the corresponding row to the “time” of the next row. In FIG. 19, the number of input packets for every one minute in a time period of 12 hours of the undetermined terminal TG1 is indicated.

The decision unit 35 executes the server identification process based on a correlation between communication data amounts of the terminals by using such traffic information 44.

That is, the decision unit 35 compares communication data amounts of a plurality of terminals for each specified measurement interval in a specified time period, and judges whether or not there is a correlation between the communication data amounts. When the decision unit 35 judges that there is a correlation between the communication data amounts of the plurality of terminals in the specified time period, the decision unit 35 judges that both of the terminals for which there is a correlation between their communication data amounts are servers.

Specifically, the decision unit 35 acquires from traffic information 44 information on the number of input packets for each specified interval in a specified time period with respect to each undetermined terminal TG1. Next, the decision unit 35 calculates the average value and the variance of the number of input packets in the specified time period for each undetermined terminal TG1, and calculates a threshold value on the basis of the calculated average value and variance. Then, the decision unit 35 specifies the time period of the specified interval in the specified time period in which the number of input packets is greater than the threshold value for each undetermined terminal TG1 and the number of input packets is maximal.

In FIG. 19, for example, the decision unit 35 calculates the average value and the standard deviation of “the number of input packets” from the “time” “09:00:00” to the “time” “20:59:00” for each combination of “port IDs” of the “MAC address of the undetermined terminal”. Next, the decision unit 35 sets the sum of the calculated average value and standard deviation as a threshold value of the combination of “port IDs” of the “MAC address of the undetermined terminal”. Then, the decision unit 35 specifies the “time” of the row in which “the number of input packets” is greater than the threshold value and is maximal. Here, there may be a plurality of specified “times”. Thus, the “time” of the row of each combination of “port IDs” of all the “MAC addresses of the undetermined terminals”, in which “the number of input packets” is greater than the threshold value and “the number of input packets” is maximal, is specified. Then, the decision unit 25 specifies terminals of the “MAC addresses of the undetermined terminals” that have the same “times” that are specified for each combination of “port IDs” of the “MAC addresses of the undetermined terminals” and the same number of specified “times”, and identifies both specified terminals as servers.

Although a threshold value is set as the sum of the average value and the standard deviation here, the threshold value maybe set to be the variance. In addition, for example, when all specified “times” of one terminal agree with “times” of the other terminal, the decision unit 35 may judge both terminals to be servers. For example, when specified “times” of one terminal A are T1 and T2, and specified “times” of the other terminal B are T1, T2 and T3, all the specified “times” of the terminal A agree with the specified “times” of the other terminal B. As a result, in this case, the terminal A and the terminal B are identified as servers.

In the embodiment, the “time” in which “the number of input packets” is greater than the threshold value and is maximal is specified for each combination of “port IDs” of the “MAC address of the undetermined terminal”. However, the “time” may be specified for each flow of the “MAC address of the undetermined terminal”.

As described above, the decision unit 35 executes the server identification process based on a correlation between communication data amounts, and records the result in the decision result information 47. Here, the decision unit 35 deletes a row in which the “MAC address” indicates a terminal that is identified as a server, from the undetermined terminal information 45.

Next, a server identification process will be described, the server identification process being directed to an undetermined terminal even after the server identification process based on a correlation between communication data amounts. Hereinafter, a terminal that is identified to be neither a server nor a client in the server identification process based on a correlation between communication data amounts is referred to as an undetermined terminal TG2.

The decision unit 35 executes a server identification process based on a correlation between communication data amounts for a longer time period (for example, 12 hours or one day) on the undetermined terminal TG2. The server identification process based on a correlation between communication data amounts in a longer time period is the same as the above-described server identification process based on a correlation between communication data amounts, except that a time period for which a decision is made and a measurement interval of the number of input packets is long.

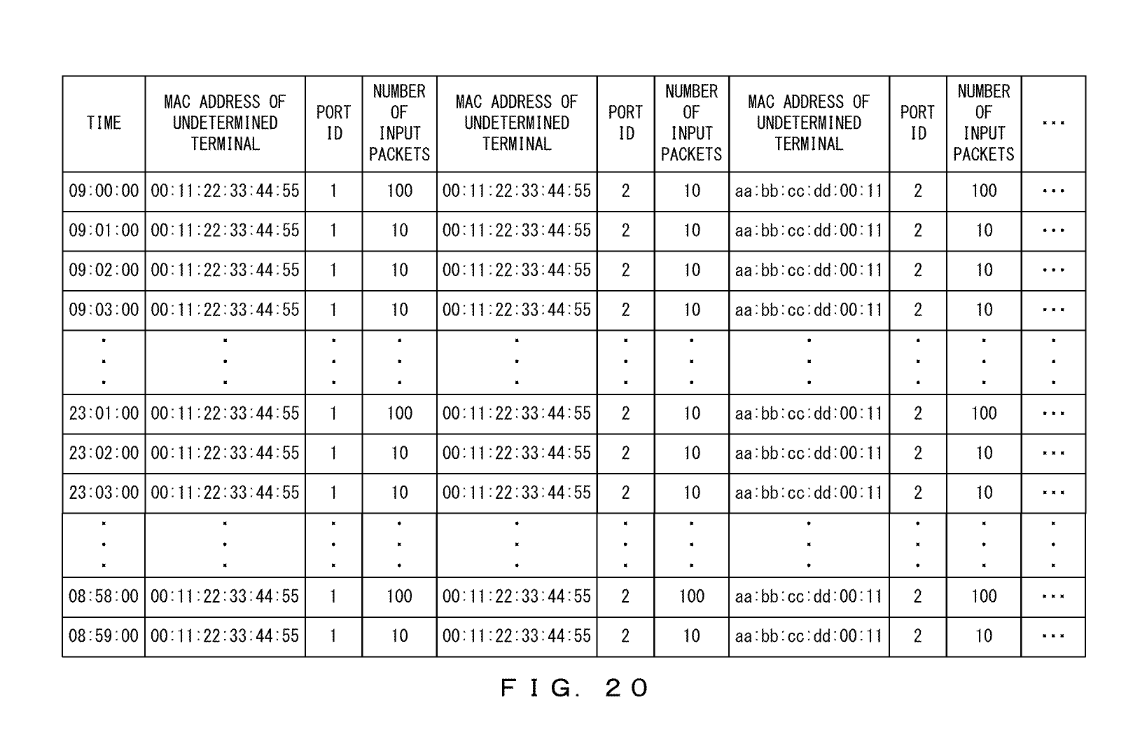

FIG. 20 illustrates an example of traffic management information that is used in the server identification process based on a communication data amount for a longer time period. In FIG. 20, the difference in the “time” of the traffic management information of a time period between a first row and a last row is 24 hours, and is longer when compared with that in FIG. 19.

The specifying unit 36 execute a failure specifying process. That is, the specifying unit 36 executes a failure specifying process based on the communication data amount of a terminal, and a failure specifying process that uses network tomography.

First, the failure specifying process based on the communication data amount of a terminal will be described.

In the failure specifying process based on the communication data amount, the specifying unit 36 judges a failure of a target terminal on the basis of a change (increase and decrease) in an amount of data that is communicated between the failure decision target terminal and a maintenance terminal.

At first, the specifying unit 36 specifies a maintenance terminal from among a plurality of terminals that are included in the network 20. The maintenance terminal periodically performs polling with a ping or the like on a plurality of maintenance target terminals. The maintenance terminal belongs to an undetermined terminal as a result of the identification process based on a correlation between communication data amounts when the plurality of maintenance target terminals are normal. This is because the number of input packets to the maintenance terminal has little fluctuation in time series and there is no maximal value that exceeds a variance value. Taking these into consideration, the specifying unit 36 specifies the maintenance terminal on the basis of the number of flows to other terminals that are included in the network 20 (the number of other terminals that are logically connected) from among terminals that belong to undetermined terminals as a result of the identification process based on the correlation between the communication data amounts. That is, the specifying unit 36 specifies as a maintenance terminal a terminal that is logically connected to all the terminals that are included in the network 20 from among terminals that belong to undetermined terminals as a result of an identification process based on a correlation between communication data amounts.

Specifically, the specifying unit 36 specifies a maintenance terminal on the basis of the undetermined terminal information 45 and the path information 42. That is, the specifying unit 36 specifies, by using the path information 42, a terminal that is logically connected to all the terminals that are included in the network 20 from among terminals that are included in the undetermined terminal information 45, on which the result of the identification process based on a correlation between communication data amounts is reflected.

For example, the specification unit 36 at first extracts all the rows in which an undetermined terminal is included in any of the “nodes” of path information 42. Then, the specifying unit 36 specifies a terminal that is included in “nodes” of all the extracted rows. Then, the specifying unit 36 judges whether or not each specified terminal corresponds to all the terminals that are included in the network 20. When the specified terminal corresponds to all the terminals that are included in the network 20, the specifying unit 36 specifies as a maintenance terminal the undetermined terminal.

When the maintenance terminal is specified, the specifying unit 36 collects a data amount of communication between the maintenance terminal and a maintenance target terminal that is logically connected to the maintenance terminal for each specified interval in a specified time period, and records the data amount as maintenance management information 46. That is, the specifying unit 36 generates maintenance management information 46 from topology information and flow information that are input from the collection unit 32.

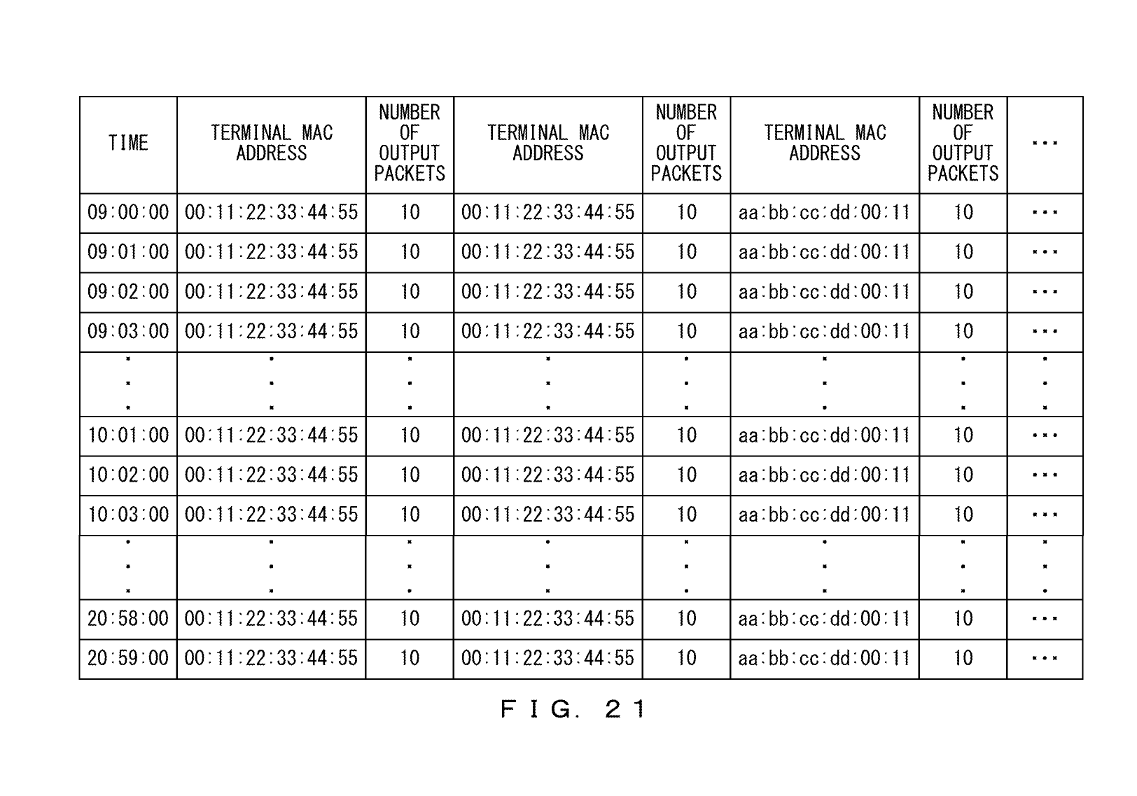

The maintenance management information 46 stores in an associated manner the number of output packets from the maintenance terminal to each terminal for each specified interval in a specified time period. FIG. 21 illustrates one example of the configuration of the maintenance management information 46. In FIG. 21, the maintenance management information 46 stores a data item, a “time” and a combination of data items, a “terminal MAC address”, and “the number of output packets” in association with each other. The “time” indicates a time of a specified time interval. The “terminal MAC address” indicates a MAC address of a terminal that is logically connected to the maintenance terminal. “The number of output packets” indicates the number of output packets that is output to the terminal of the “terminal MAC address” from the maintenance terminal from the “time” of the corresponding row to the “time” of the next row. In each row, as many of the combinations of the data items, the “terminal MAC address”, and “the number of output packets” as the number of terminals that are logically connected to the maintenance terminal are included. In FIG. 21, the number of output packets to each terminal from the maintenance terminal for every minute in the time period of 12 hours is indicated.

Next, from the maintenance management information 46, the specifying unit 36 specifies a terminal for which there is a time at which an amount of data that is communicated with the maintenance terminal is a specified threshold value or greater in a specified time period.

Specifically, the specification unit 36 acquires from the maintenance management information 46 the number of packets that are output to each terminal from the maintenance terminal for each specified interval in the specified time period. Next, the specifying unit 36 calculates the average value and variance of the number of packets that are output from the maintenance terminal in a specified time period for each terminal, and calculates a threshold value on the basis of the calculated average value and variance. Then, the specifying unit 36 specifies a terminal that has a period of a specified interval in the specified time period in which the number of output packets from the maintenance terminal is greater than the threshold value.

In FIG. 21, for example, the specifying unit 36 calculates the average value and the standard deviation of “the number of output packets” from the “time” “09:00:00” to the “time” “20:59:00” for each terminal. Next, the specifying unit 36 sets the sum of the calculated average value and standard deviation as a threshold value of the terminal. Then, the specifying unit 36 judges whether or not there is a row in which “the number of output packets” of the corresponding terminal is greater than the threshold value, and specifies the terminal for which there is a row in which “the number of output packets” of the corresponding terminal is greater than the threshold value. Hereinafter, the terminal that is specified here may be referred to as a failure monitoring target terminal.

In the specified failure monitoring target terminal, the specifying unit 36 judges whether or not there is no output data even though there is input data to the failure monitoring target terminal in all the flows of the failure monitoring target with the terminal that is different from the maintenance terminal. When the specifying unit 36 judges that there is no output data even though there is input data, the specifying unit 36 judges that a failure has occurred in the failure monitoring target terminal.

A decision as to whether of not there is output data even though there is input data to a failure monitoring target terminal is made by the specifying unit 36 on the basis of the flow management information 43. For example, the specifying unit 36 extracts all the rows in which the “destination MAC address” agrees with the MAC address of the failure monitoring target terminal and the value of the “source MAC address” is different from the MAC address of the maintenance terminal in the flow management information 43. Then, the specifying unit 36 judges whether or not “the number of input packets” is not 0 and “the number of output packets” is 0 with respect to all the extracted rows. When the specifying unit 36 judges that “the number of input packets” is not 0 and “the number of output packets” is 0 in all the extracted rows, the specifying unit 36 executes the following process. That is, the specifying unit 36 extracts all the rows in which “source MAC address” agrees with the MAC address of the failure monitoring target terminal and the “destination MAC address” is different from the MAC address of the maintenance terminal. Then, the specifying unit 36 judges whether or not “the number of output packets” is not 0 and “the number of input packets” is 0 with respect to all the extracted rows. When the specifying unit 36 judges that “the number of output packets” is not 0 and “the number of input packets” is 0 in all the extracted rows, the specifying unit 36 judges that a failure has occurred in the failure monitoring target terminal.

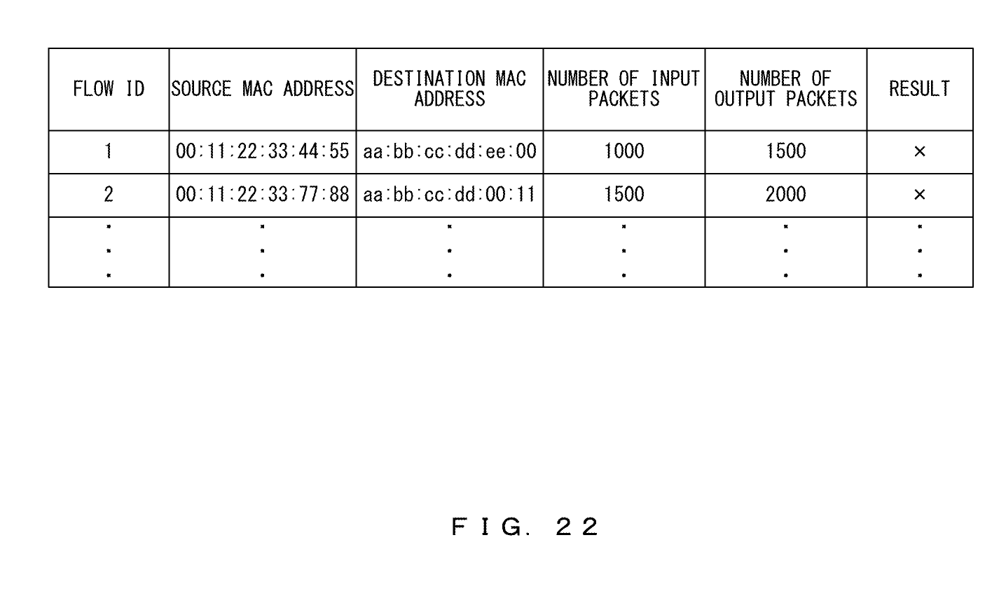

Next, the failure specifying process using network tomography in the embodiment will be described. The specifying unit 36 at first executes failure monitoring of the network using the network tomography technique, which was described with reference to FIGS. 3-5. The specifying unit 36 records the result of execution of the network failure monitoring using the network tomography technique on flow-state management information 48. FIG. 22 illustrates an example of the flow-state management information 48. The flow-state management information 48 stores flow identification information and information that indicates whether or not a failure has occurred on a flow path or a terminal in association with each other. FIG. 22 indicates that a failure has occurred in a flow of the “flow ID” for which the data item “result” is indicated as “x”.

When the specifying unit 36 judges that a failure has occurred in any of (or a plurality of) the links that are included in the network 20 as a result of failure monitoring using network tomography, the specifying unit 36 executes the following process. That is, the specifying unit 36 refers to the link information 41 or path information 42, and judges whether or not a link in which it is judged that a failure has occurred is a link that is connected to a server. A decision as to whether or not a link in which it has been judged that a failure has occurred is a link that is connected to a server maybe made by the specifying unit 36 on the basis of topology information. When the specifying unit 36 judges that the link in which it has been judged that a failure has occurred is a link that is connected to a server, the specifying unit 36 compares the number of input packets and the number of output packets to and from the server to which the link in which the failure has occurred is connected. As a result, when the specifying unit 36 judges that the number of input packets to the server to which the link in which the failure has occurred is connected is greater that the number of output packets from the server, the specifying unit 36 judges that a failure has occurred in the server to which the link in which the failure has occurred is connected.

The output unit 37 displays server identification results and displays a failure portion that is judged by network tomography. Thus, a management person can obtain information that is necessary at the time of a system failure.

Specifically, the output unit 37 outputs information on an identification result of a server identification process that is executed by the decision unit 35 and information on a specification result of a failure specifying process that is executed by the specifying unit 36 to a specified display device that is connected to the monitoring apparatus 24, for example.

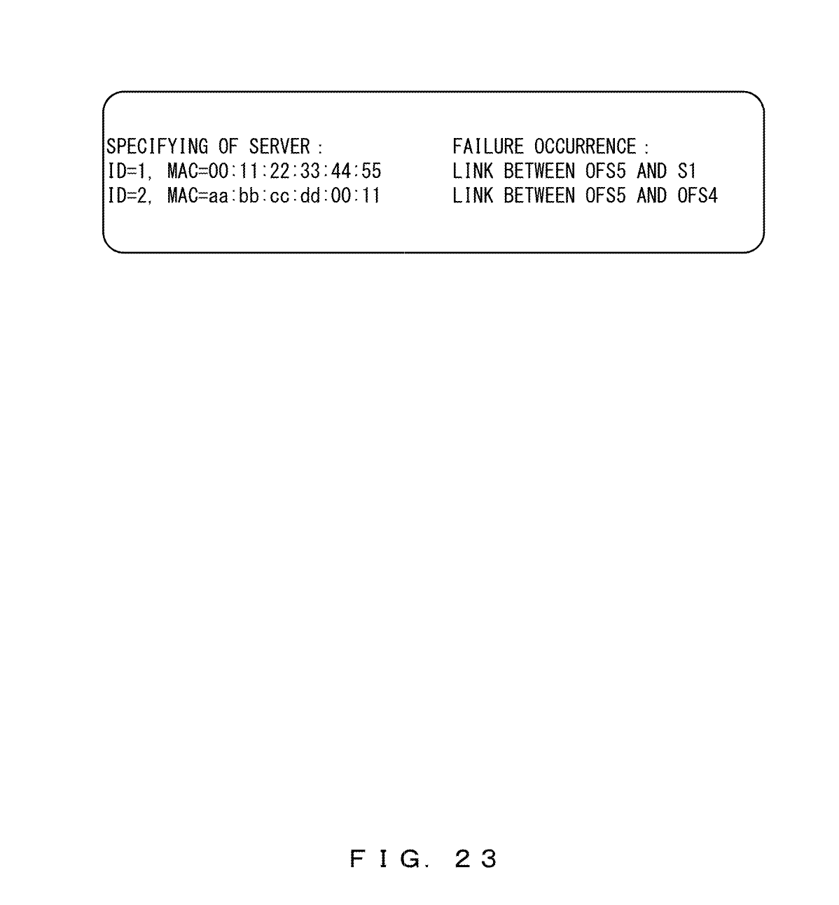

FIG. 23 is an example of information that is output by the output unit 37. In FIG. 23, the MAC addresses “00:11:22:33:44:55” and “aa:bb:cc:dd:00:11” of the terminals that are identified as servers in the server identification process are indicated. In addition, “link of OFS5 and S1”, “link of OFS5 and OFS4”, and “S1” are indicated as identification information of a server or a link in which a failure has occurred, which is specified by the failure specifying process. Each of “OFS4” and “OFS5” is an example of switch identification information, and “S1” is an example of server identification information. The output unit 37 may output decision result information 47 and flow-state management information 48.

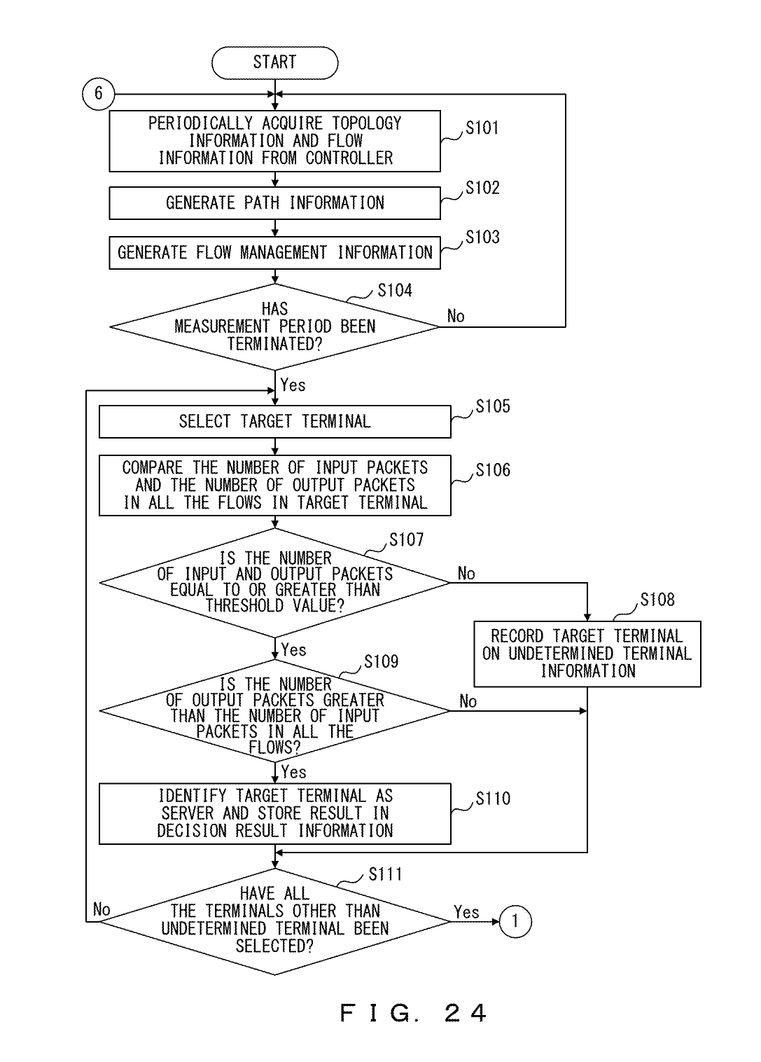

Next, an operation flow of the server identification process will be described with reference to FIGS. 24-28. FIGS. 24-28 are a flowchart (parts 1-5) illustrating details of the server identification process.

In FIG. 24, the collection unit 32 at first time periodically acquires topology information and flow information from the controller 22 (S101). The collection unit 32 outputs the acquired topology information and flow information to the flow information management unit 33.

Next, the flow information management unit 33 generates the link information 41 and the path information 42 by using the topology information and flow information that are input from the collection unit 32, and stores the link information 41 and the path information 42 in the storage unit (S102).

Next, the flow information management unit 33 generates flow management information 43 by using the topology information and the flow information that are input from the collection unit 32, and stores the flow management information 43 in the storage unit 31 (S103).

Next, the collection unit 32 judges whether or not a specified measurement time period is terminated (S104). It is assumed that the specified measurement time period in this step is a value that is set in advance, and is stored in the specified storage unit 31. When it is judged that the specified measurement time period is not terminated (No in S104), the process transitions to S101.

On the other hand, when it is judged that the specified measurement time period is terminated (Yes in S104), the decision unit 35 selects as a target terminal one terminal from among target terminals of the server identification process (S105).

Next, with respect to the target terminal that is selected in S105, the decision unit 35 compares the number of input packets to the target terminal and the number of output packets from the target terminal for each of all the flows of information that is communicated by the target terminal (S106).

Next, the decision unit 35 judges whether or not the total of the number of input and output packets of all the flows that are communicated by the target terminal is a specified threshold value or greater (S107). It is assumed that the specified threshold value in S107 is a value that is set in advance, and is stored in the specified storage unit 31. When the decision unit 35 judges that the total of the number of input and output packets of all the flows that are communicated by the target terminal is less than the specified threshold value (No in S107), the decision unit 35 stores information on the target terminal as information on an undetermined terminal, in information on undetermined terminals (S108). Then, the process transitions to S111.

On the other hand, in S107, when the decision unit 35 judges that the total of the number of input and output packets of all the flows that are communicated by the target terminal is a specified threshold value or greater (Yes in S107), the decision unit 35 executes the following process. That is, the decision unit 35 judges whether or not the number of output packets from the target terminal is greater than the number of input packets to the target terminal (S109).

When it is judged that the number of output packets from the target terminal is not greater than the number of input packets to the target terminal in any flow that is communicated by the target terminal (No in S109), the process transitions to S111.

On the other hand, when the decision unit 35 judges that the number of output packets from the target terminal is greater than the number of input packets to the target terminal in all the flows that are communicated by the target terminal (Yes in S109), the decision unit 35 judges the target terminal to be a server, and stores the result in the decision result information 47 (S110).

Next, in S105, the decision unit 35 judges whether or not all the terminals except the undetermined terminal, the information on which is stored in information on undetermined terminals, have already been selected (S111). When it is judged that any terminal except the undetermined terminal has not yet been selected in S105 (No in S111), the process transitions to S105, and the decision unit 35 selects as a target terminal one of the terminals that have not yet been selected (S105).

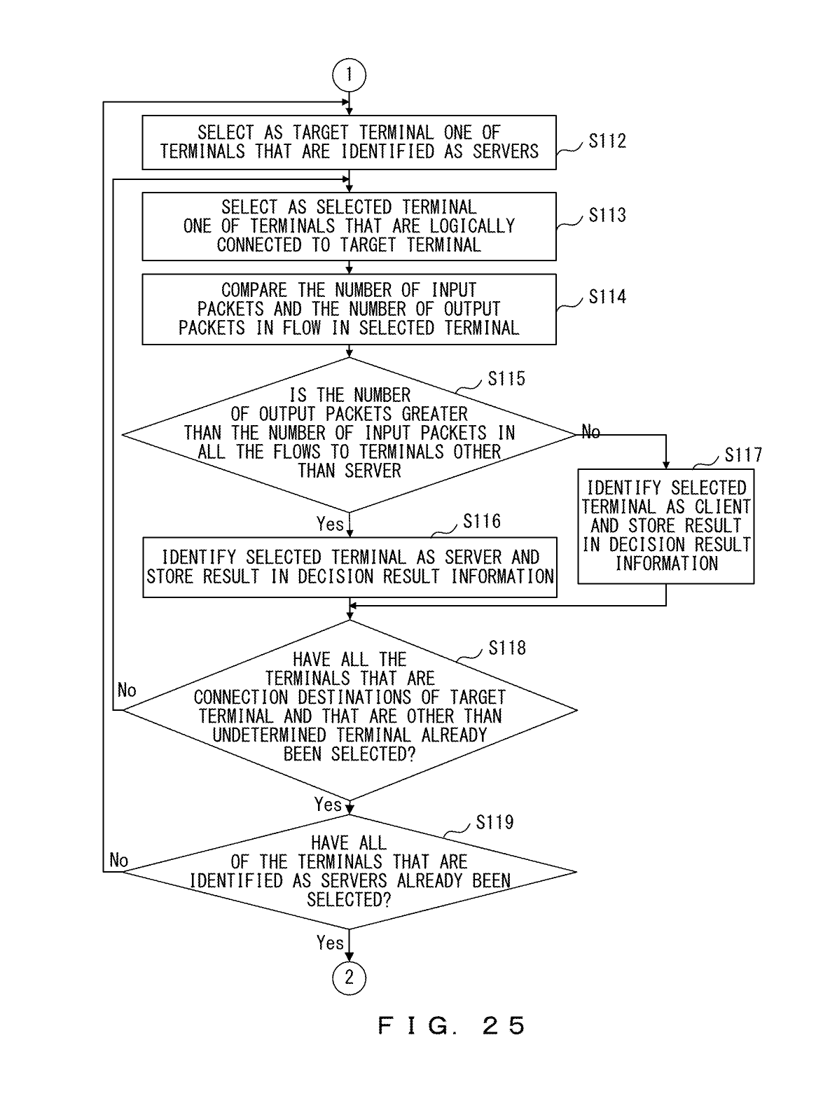

On the other hand, in S111, when it is judged that all the terminals except the undetermined terminal have already been selected in S105 (Yes in S111), the process transitions to S112 in FIG. 25.

In S112 in FIG. 25, the decision unit 35 newly selects one of the terminals which have been identified as servers in S110 as a target terminal (S112).

Next, the decision unit 35 selects as a selection terminal one of the terminals that are logically connected to the target terminal (S113). That is, the decision unit 35 specifies the terminal that is logically connected to the target terminal with reference to the path information 42 or the flow management information 43.

Next, the decision unit 35 compares the number of input packets to the selected terminal and the number of output packets from the selected terminal for each of all the flows that are communicated with terminals that are different from the target terminal, in the selected terminal that has been selected in S113. (S114).

Next, the decision unit 35 judges whether or not the number of output packets from the selected terminal is greater than the number of input packets to the selected terminal in all the flows that the selected terminal communicates with the terminals that are different from the target terminal (S115).

When the decision unit 35 judges that the number of output packets from the selected terminal is greater than the number of input packets to the selected terminal in all the flows that the selected terminal communicates with the terminals that are different from the target terminal (Yes in S115), the decision unit 35 executes the following process. That is, the decision unit 35 identifies the selected terminal as a server, and stores the result in the decision result information 47 (S116). Then, the process transitions to S118.

On the other hand, when the decision unit 35 judges that the number of output packets from the selected terminal is not greater than the number of input packets to the selected terminal in any of the flows that the selected terminal communicates with the terminals that are different from the target terminal (No in S115), the decision unit 35 executes the following process. That is, the decision unit 35 identifies the selected terminal as a client, and stores the result in the decision result information 47 (S117). Then, the process transitions to S118.

Next, in S113, the decision unit 35 judges whether or not all the terminals that are logically connected to the target terminal have already been selected (S118). When it is judged that there are any terminals that are logically connected to the target terminal that have not yet been selected in S113 (No in S118), the process transitions to S113, and the decision unit 35 selects as a selected terminal one of the terminals that have not yet been selected (S113).

On the other hand, in S118, when the decision unit 35 judges that all the terminals that are logically connected to the target terminal have already been selected in S113 (Yes in S118), the decision unit 35 judges whether or not all the terminals that are identified as servers, which are stored in the decision result information 47, have already been selected (S119). When it is judged that there are any of the terminals that are identified as servers that have not yet been selected in S112 (No in S119), the process transitions to S112, and the decision unit 35 selects as a target terminal one of the terminals that have not yet been selected (S112).

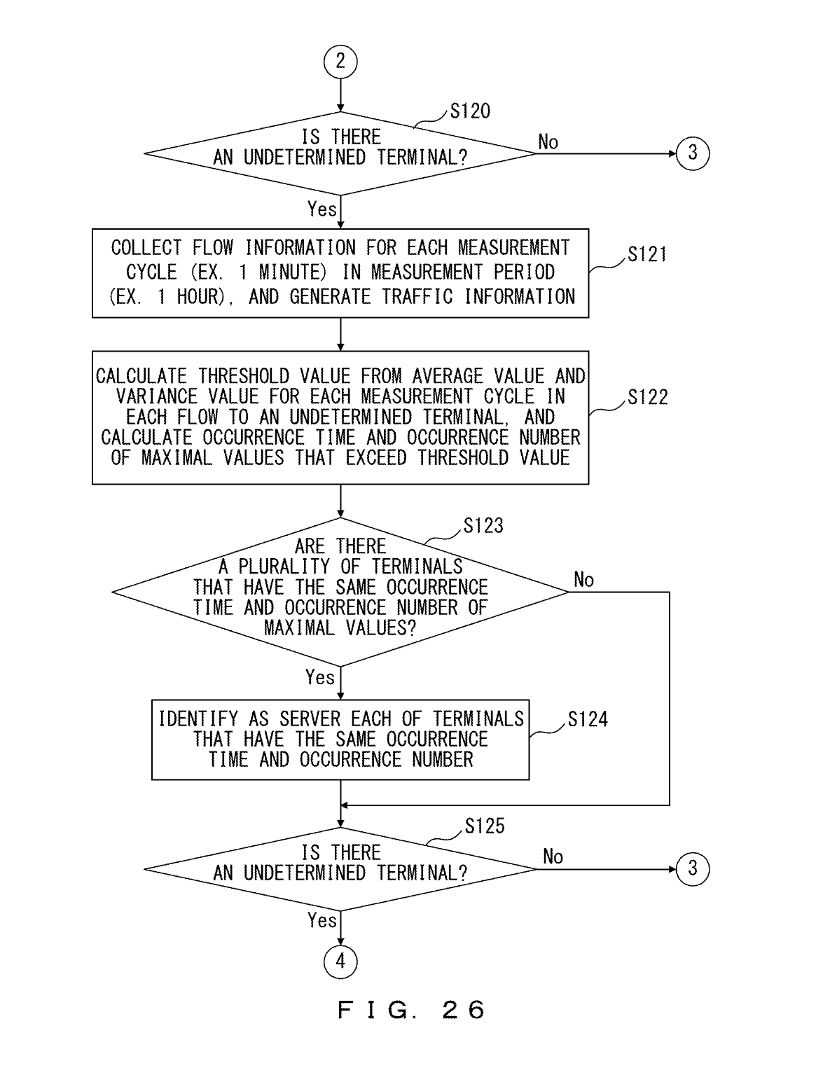

On the other hand, in S119, when it is judged that all the terminals that are identified as servers have already been selected in S112 (Yes in S119), the process transitions to S120 in FIG. 26.

In S120 in FIG. 26, the decision unit 35 judges whether or not there is an undetermined terminal (S120). Since the decision results for the terminals that are identified as a server or not are stored in the decision result information 47, a terminal whose corresponding entry is not stored in the decision result information 47 is an undetermined terminal. Here, the decision unit 35 stores information on a terminal that is not stored in the decision result information 47 in the undetermined terminal information 45. The undetermined terminal in S120 may be a terminal that is recorded in S108 on the undetermined terminal information 45.

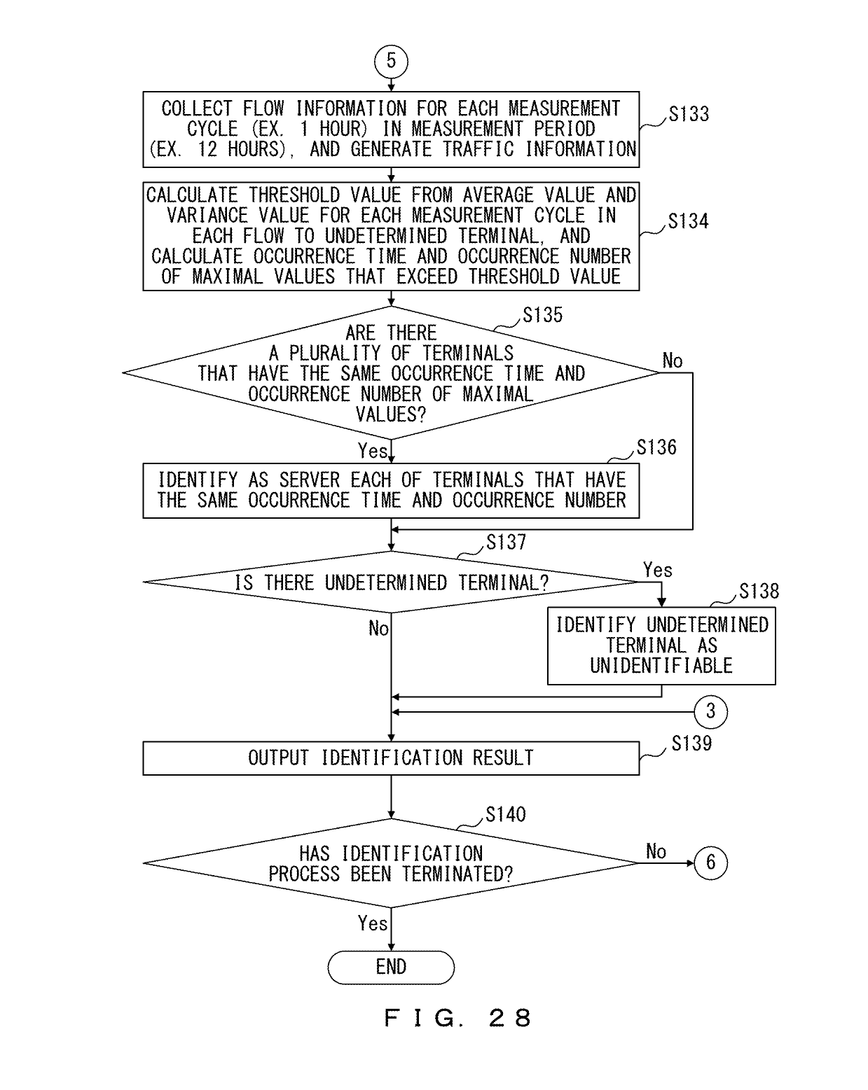

When it is judged that there are no undetermined terminals (No in S120), the process transitions to S139 in FIG. 28.

When it is judged that there is an undetermined terminal in S120 (Yes in S120), the collection unit 32 collects flow information for each specified measurement cycle in a specified measurement time period, and outputs the flow information to the traffic information management unit 34. The traffic information management unit 34 generates traffic information 44 by using the flow information that is input from the collection unit 32, and records the traffic information 44 in the storage unit 31 (S121).

Next, the decision unit 35 calculates a threshold value on the basis of the average value and the variance value for each measurement cycle of the number of input packets in each flow in which information is communicated to an undetermined terminal for each undetermined terminal, and calculates an occurence time for the maximal value of the number of input packets that exceeds the calculated threshold value and the occurence number of maximal values (S122).

Next, the decision unit 35 judges whether or not the occurence time for the maximal value and the occurence number of maximal values of an undetermined terminal agree with those of another undetermined terminal, and judges whether or not there are a plurality of terminals that have the same occurence time for the maximal value and the same occurence number of maximal values (S123). When it is judged that there are no terminals that have the same occurence time for the maximal value and the same occurence number of maximal values (No in S123), the process transitions to S125.

When it is judged in S123 that there are a plurality of terminals that have the same occurence time for the maximal value and the same occurence number of maximal values (Yes in S123), the decision unit 35 identifies as servers the plurality of terminals that have the same occurence time for the maximal value and the same occurence number of maximal values, and stores the result in the decision result information 47 (S124). The decision unit 35 deletes the entry that corresponds to the terminal that is identified as a server here from the undetermined terminal information 45.

Next, the decision unit 35 judges whether or not there is an undetermined terminal (S125). When it is judged that there are no undetermined terminals (No in S125), the process transitions to S139 in FIG. 28.

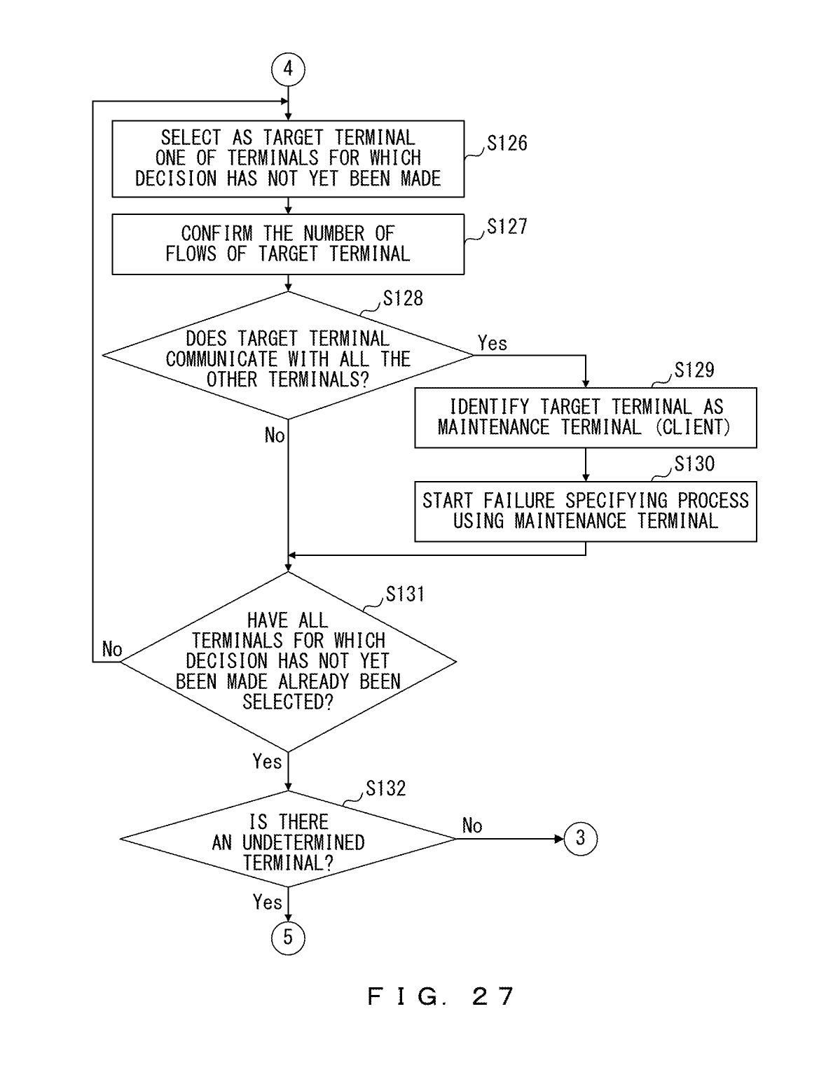

On the other hand, when it is judge that there is an undetermined terminal (Yes in S125), the process transitions to S126 in FIG. 27.

In S126 in FIG. 27, the specifying unit 36 newly selects as a target terminal one of the undetermined terminals (S126).

Next, the decision unit 36 calculates and confirms the number of flows of the target terminal (S127). That is, the decision unit 36 calculates the number of flows of the target terminal on the basis of the flow management information 43.

Next, the specifying unit 36 judges whether or not the target terminal communicates with all the other terminals on the basis of the number of flows of the target terminal, the number being confirmed in S127 (S128). Specifically, for example, the specifying unit 36 judges whether or not the number of flows of the target terminal, which is confirmed in S127, agrees with the number that is obtained by subtracting 1 from the number of terminals that are included in the network 20. When it is judged that the target terminal does not communicate with any of the other terminals (No in S128), the process transitions to S131.

On the other hand, in S128, when it is judged that the target terminal communicates with all the other terminals (Yes in S128), the specifying unit 36 identifies the target terminal as a maintenance terminal (S129). In addition, the specifying unit 36 identifies the target terminal as a client, and records the result in the decision result information 47. Here, the specifying unit 36 deletes the entry that corresponds to the terminal that is identified as a client here from the undetermined terminal information 45.

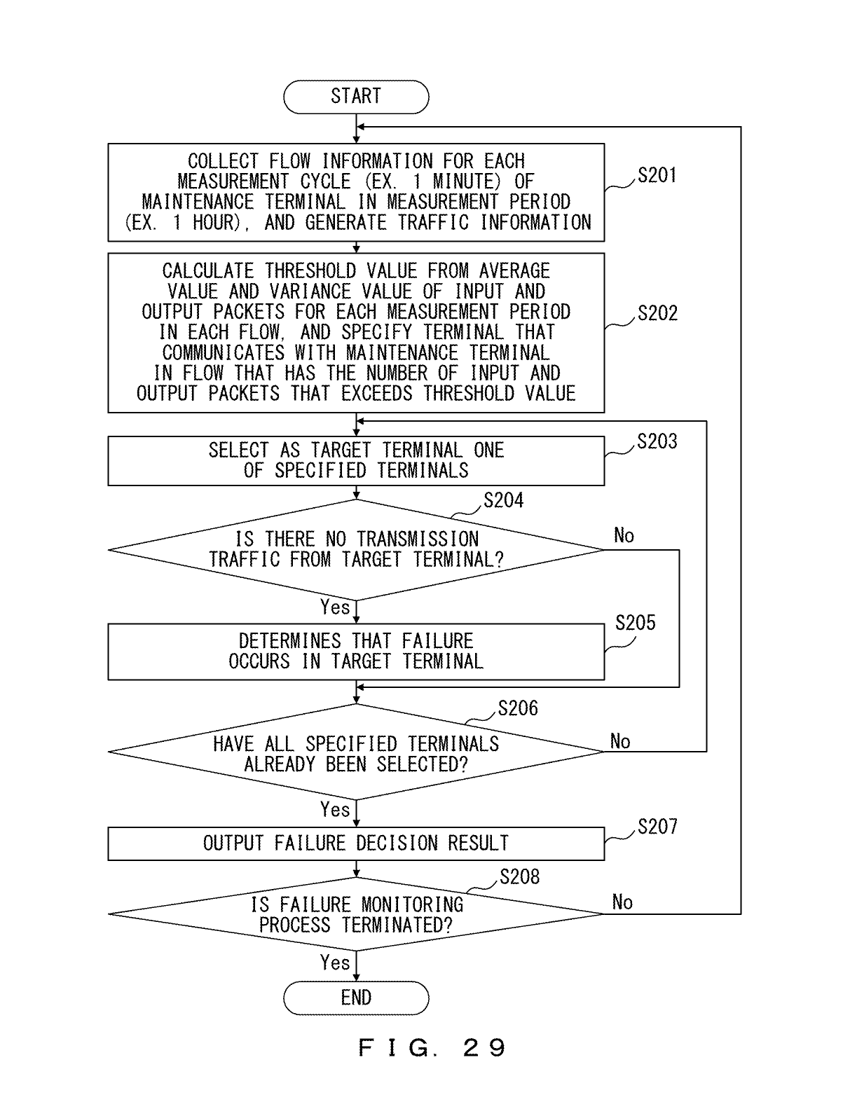

Next, the specifying unit 36 starts the failure specifying process that is illustrated in the flow in FIG. 29, which will be described hereinafter (S130). Then, the process transitions to S131.

Next, the specifying unit 36 judges whether or not all of the undetermined terminals have already been selected in S126 (S131). When it is judged that there are any of the undetermined terminals that have not yet been selected (No in S131), the process transitions to S126, and the specifying unit 36 newly selects as a target terminal one of the undetermined terminals which have not yet been selected (S126).

On the other hand, in S131, when it is judged that all the undetermined terminals have already been selected (Yes in S131), the specifying unit 36 judges whether or not there is an undetermined terminal (S132). When it is judged that there are no undetermined terminals (No in S132), the process transitions to S139 in FIG. 28.

On the other hand, in S132, when it is judged that there are undetermined terminals (Yes in S132), the process transitions to S133 in FIG. 28.

In S133 in FIG. 28, the collection unit 32 collects flow information for each specified measurement cycle in a specified measurement time period that is longer than the measurement time period in S121, and outputs the flow information to the traffic information management unit 34. The traffic information management unit 34 generates traffic information 44 by using the flow information that is input from the collection unit 32, and records the traffic information 44 in the storage unit 31 (S133).

Next, the decision unit 35 calculates a threshold value on the basis of the average value and the variance value for each measurement cycle of the number of input packets in each flow in which information is communicated to an undetermined terminal for each undetermined terminal, and calculates an occurence time for a maximal value and the occurence number of maximal values of the number of input packets that exceeds the calculated threshold value (S134).

Next, the decision unit 35 judges whether or not there are a plurality of terminals that have the same occurence time for the maximal value and the same occurence number of maximal values (S135). When it is judged that there are no terminals that have the same occurence time for the maximal value and the same occurence number of maximal values (No in S135), the process transitions to S137.

When it is judged in S135 that there are a plurality of terminals that have the same occurence time for the maximal value and the same occurence number of maximal values (Yes in S135), the decision unit 35 identifies as servers the plurality of terminals that have the same occurence time for the maximal value and the same occurence number of maximal values, and stores the result in the decision result information 47 (S136). The decision unit 35 deletes the entries that correspond to the terminals that are identified as servers here from the undetermined terminal information 45.

Next, the decision unit 35 judges whether or not there is an undetermined terminal (S137). When it is judged that there are no undetermined terminals (No in S137), the process transitions to S139.

On the other hand, in S137, when it is judged that there is an undetermined terminal (Yes in S137), the decision unit 35 judges the undetermined terminal to be unidentifiable (S138). The decision unit 35 may record in the decision result information 47 identification information on the undetermined terminal that is judged to be unidentifiable here.

Next, in S139, the output unit 37 outputs the identification result (S139). Next, the decision unit 35 judges whether or not the server identification process will be terminated (S140). Whether or not the identification process will be terminated is judged on the basis of information that is set and stored in advance in the specified storage unit 31. For example, a plurality of time periods for continuing measurement of topology information and flow information that are collected by the collection unit 32 are defined in advance (for example, 1 hour and 1 day) and are stored in the storage unit 31. Then the decision unit 35 judges that the identification process will not be terminated when the defined time periods for continuing measurement have not ended when there is an undetermined terminal. On the other hand, the decision unit 35 judges that the identification process will be terminated when there are no undetermined terminals, or when the defined time periods for continuing measurement end when there is an undetermined terminal.

In S140, when it is judged by the decision unit 35 that the server identification process will not be terminated (No in S140), the process transitions to S101 in FIG. 24. On the other hand, when it is judged by the decision unit 35 that the server identification process will be terminated (Yes in S140), the process is terminated.

Next, the operation flow of the failure specifying process that is started in S130 will be described. FIG. 29 is a flowchart illustrating details of the failure specifying process based on the communication data amount of a terminal.

In FIG. 29, at first, the collection unit 32 collects flow information for each specified measurement cycle of the maintenance terminal that is specified in S130 in a specified measurement time period, and outputs it to the specifying unit 36. The specifying unit 36 generates maintenance management information 46 by using flow information that is input from the collection unit 32, and records the maintenance management information 46 in the storage unit 31 (S201).

Next, the specifying unit 36 calculates a threshold value from the average value and the variance of the number of input and output packets for each specified measurement cycle in each flow of the maintenance terminal, and specifies a terminal that communicates with the maintenance terminal in a flow that has a number of input and output packets that exceeds the threshold value (S202). The terminal that is specified in S202 is a terminal that is a failure monitoring target terminal.

Next, the specifying unit 36 newly selects as a target terminal one of the terminals that are failure monitoring targets, which have been specified in S202 (S203).

Next, the specifying unit 36 judges whether or not there is transmission traffic from the target terminal (S204). Specifically, for example, the specifying unit 36 judges whether or not there is no output data to a terminal that is different from the maintenance terminal even though there is input data to the target terminal from the terminal that is different from the maintenance terminal, on the basis of the flow management information 43. When it is judged that there is transmission traffic from the target terminal (No in S204), the process transitions to S206.

On the other hand, in S204, when it is judged that there is no transmission traffic from the target terminal (Yes in S204), the specifying unit 36 judges that a failure has occurred in the target terminal (S205). Then, the specifying unit 36 records the target terminal and information that indicates that a failure has occurred in association with each other in the storage unit 31.

Next, the specifying unit 36 judges whether or not all of the terminals that are specified in S202 have already been selected in S203 (S206). When it is judged that there are any of the terminals that were specified in S202 that have not yet been selected (No in S206), the process transitions to S203, and the specifying unit 36 selects as a target terminal one of the terminals that have not yet been selected from among the terminals that have been specified in S202 (S203).

On the other hand, when it has been judged that all of the terminals that have been specified in S202 have been selected in S203 (Yes in S206), the output unit 37 outputs the failure decision result (S207). For example, the output unit 37 outputs identification information of the terminal in which it is judged that a failure has occurred in S205 together with information that indicates that a failure has occurred.

Next, the specifying unit 36 judges whether or not the failure specifying process will be terminated (S208). Whether or not the failure specifying process will be terminated in S208 is judged on the basis of information that is set and stored in advance in the specified storage unit 31. For example, a plurality of time periods for continuing measurement of flow information that is collected by the collection unit 32 are defined in advance and are stored in the storage unit 31. Then, the specifying unit 36 judges that the specifying process will not be terminated when the measurement time period in S201 does not exceed the predefined time periods for continuing the measurement. On the other hand, the specifying unit 36 judges that the specifying process will be terminated when the measurement time period in S201 exceeds the predefined time periods for continuing the measurement.

In S208, when it is judged by the specifying unit 36 that the failure specifying process will not be terminated (No in S208), the process transitions to S201. On the other hand, in S208, when it is judged by the specifying unit 36 that the failure specifying process will be terminated (Yes in S208), the process is terminated.

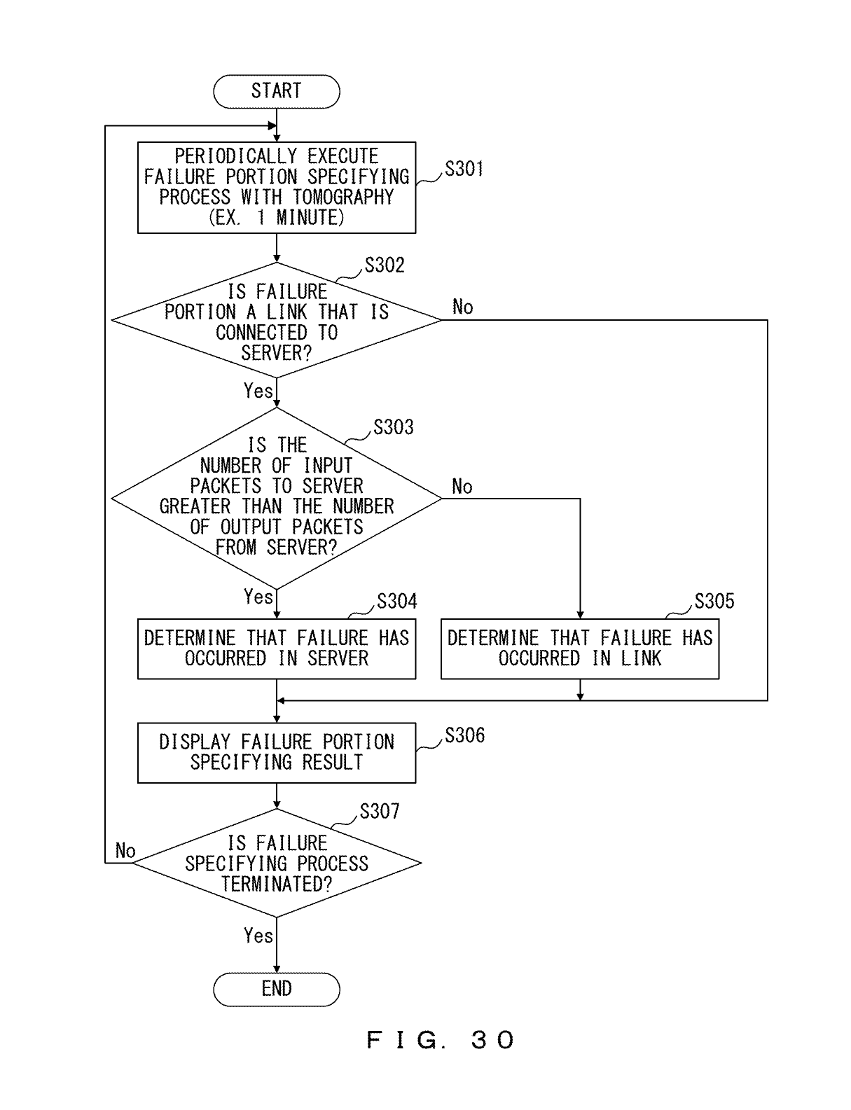

Next, the operation flow of the failure specifying process using network tomography will be described. FIG. 30 is a flowchart illustrating details of the failure specifying process using network tomography.

In FIG. 30, the specifying unit 36 periodically executes a failure portion specifying process using network tomography (S301).

Next, the specifying unit 36 judges whether or not a link in which it has been judged that a failure has occurred in S301 is a link that is connected to a server (S302). When it is judged that the link in which it has been judged that a failure has occurred in S301 is not a link that is connected to a server (No in S302), the process transitions to S306.

On the other hand, when it is judged that the link in which it is judged that a failure has occurred in S301 is a link that is connected to a server (Yes in S302), the specifying unit 36 executes the following process. That is, the specifying unit 36 judges whether or not the number of input packets to the server to which the link in which the failure has occurred is connected (hereinafter referred to as a faulty link connection server) is greater than the number of output packets from the faulty link connection server (S303).

In S303, when it is judged that the number of input packets to the faulty link connection server is greater than the number of output packets from the faulty link connection server (Yes in S303), the specifying unit 36 judges that a failure has occurred in the faulty link connection server (S304). Here, the specifying unit 36 may record the identification information of the server in which it is judged that the failure has occurred and information that indicates that the failure has occurred in association with each other in the storage unit 31. Then, the process transitions to S306.

On the other hand, when it is judged that the number of input packets to the faulty link connection server is not greater than the number of output packets from the faulty link connection server (No in S303), the specifying unit 36 judges that a failure has occurred in the link in which it has been judged that the failure has occurred in S301 (S305). Here, the specifying unit 36 may record the identification information of the link in which it is judged that the failure has occurred and information that indicates that the failure has occurred in association with each other in the storage unit 31. Then, the process transitions to S306.

Next, the output unit 37 outputs the specifying result of the failure portion (S306). For example, the output unit 37 outputs the identification information of the server or the link in which it has been judged that the failure has occurred in S304 or S305 and the information that indicates that the failure has occurred in association with each other.

Next, the specifying unit 36 judges whether or not the failure specifying process will be terminated (S307). Whether or not the failure specifying process will be terminated in S307 is judged on the basis of information that is set and stored in advance in the specified storage unit 31. For example, a plurality of time periods for continuing execution of network tomography are defined in advance and are stored in the storage unit 31. Then, the specifying unit 36 judges that the failure specifying process will not be terminated when the execution time period of network tomography does not exceed the predefined time periods for continuing the execution of network tomography. On the other hand, the specifying unit 36 judges that the failure specifying process will be terminated when the execution time period of network tomography exceeds the predefined time periods for continuing the execution of network tomography.

In S307, when it is judged by the specifying unit 36 that the failure specifying process will not be terminated (No in S307), the process transitions to S301. On the other hand, in S307, when it is judged by the specifying unit 36 that the failure specifying process will be terminated (Yes in S307), the process is terminated.

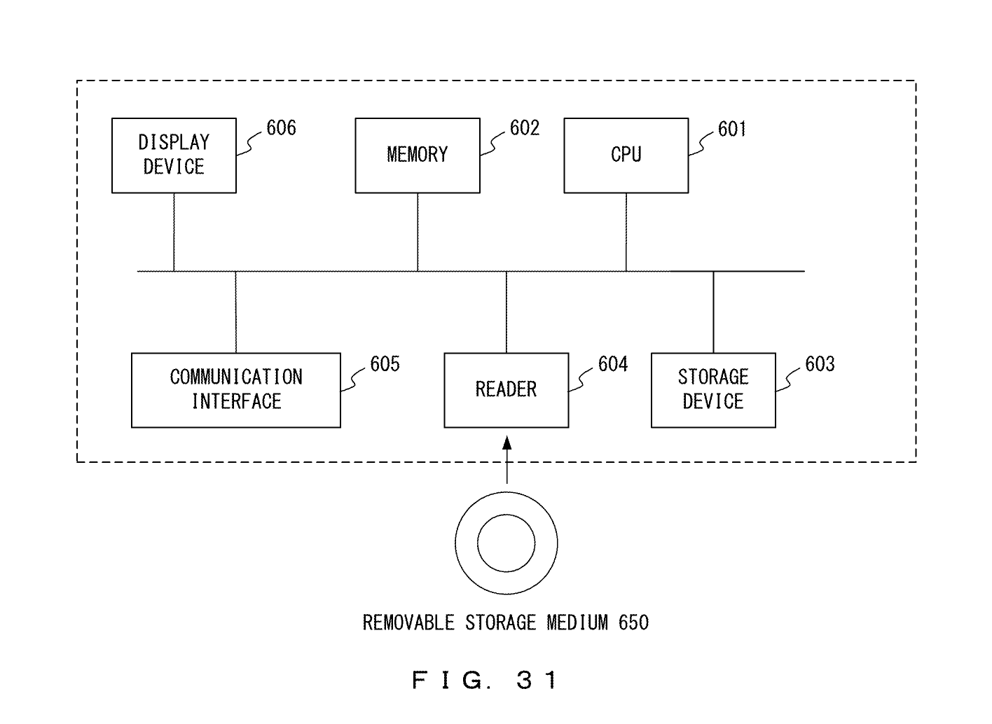

In FIG. 31, the monitoring apparatus 24 includes a CPU (Central Processing Unit) 601, a memory 602, a storage device 603, a reader 604, a communication interface 605, and a display device 606. The CPU 601, the memory 602, the storage device 603, the reader 604, the communication interface 605, and the display device 606 are connected with one another via a bus.

The CPU 601 provides some or all functions of the collection unit 32, the flow information management unit 33, the traffic information management unit 34, the decision unit 35, the specifying unit 36, and the output unit 37 by executing a program that describes procedures of the above-described flowchart by using the memory 602.

The memory 602 is for example a semiconductor memory, and is configured by including a RAM (Random Access Memory) area and a ROM (Read Only Memory) area. An example of the storage device 603 is a hard disk. The storage device 603 may be a semiconductor memory such as a flash memory. The storage device 603 may be an outboard recorder. The storage device 603 provides some or all of the functions of the storage unit 31.

The reader 604 accesses a removable storage medium 650 according to instructions from the CPU 601. The removable storage medium 650 is realized by a semiconductor device (USB memory etc.), a medium to/from which information is input/output by a magnetic action (magnetic disk etc.), a medium to/from which information is input/output by an optical action (CD-ROM, DVD, etc.), etc. The reader 604 may not be included in the monitoring apparatus 24.

The communication interface 605 collects topology information and flow information from the controller 22 via the network according to instructions from the CPU 601. Information that is output by the output unit 37 maybe output to another terminal (not illustrated) that is connected via the communication interface 605.

The display device 606 displays information that is output by the output unit 37. The display device 606 may not be included in the monitoring apparatus 24.

The program of the embodiment is provided to the monitoring apparatus 24, for example, in the following form.
(1) installed in advance in the storage device 603.
(2) provided by the removable storage medium 650.
(3) provided from a program server (not illustrated) via the communication interface 605.

In addition, part of the monitoring apparatus 24 of the embodiment may be realized by hardware. Alternatively, the monitoring apparatus 24 of the embodiment maybe realized by a combination of software and hardware.

Although the monitoring apparatus 24 collects topology information from the controller 22 in FIG. 2, the monitoring apparatus 24 may receive topology information and flow information from a switch or another information processing apparatus without the controller 22 as long as the monitoring apparatus 24 may acquire topology information and flow information. In addition, although a MAC address is used as terminal identification information in the embodiment, the terminal identification information is not limited to a MAC address as long as it is information that can identify a terminal.

The server identification process based on the comparison between an input data amount and an output data amount is executed for each flow of information that is transmitted and received by each terminal, but the server identification process may be executed by the comparison between the total of the input data amount and the total of the output data amount in a specified time period of a terminal.

The identification apparatus of the embodiment can identify whether or not a terminal is a server from the information related to communication between terminals. According to the embodiment, whether or not a terminal is a server can be identified from information to a data link layer (second layer) of an OSI (Open Systems Interconnection) reference model. That is, according to the embodiment, whether or not a terminal is a server can be identified on the basis of the MAC address of the terminal and the communicated data amount of the terminal.

According to the embodiment, whether or not a terminal with a small communication data amount is a server can be identified on the basis of a correlation between a communication data amounts of terminals. According to the embodiment, a server in which a failure has occurred can be specified on the basis of the information related to communication between terminals. According to the embodiment, a failure that occurs in a server can be distinguished from a failure that occurs in a link on the basis of the information related to communication between terminals.

The present embodiment is not limited to the embodiment described above, and various configurations and embodiments can be taken within the scope not deviating from the gist of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An identification apparatus comprising:
a processor which executes a process including:
acquiring information that includes an amount of information that is communicated between a plurality of communication apparatuses that communicate information; and
identifying as a server apparatus a first communication apparatus that is any of the plurality of communication apparatuses, when an amount of information that is output from the first communication apparatus is equal to or greater than an amount of information that is input to the first communication apparatus in communication in a specified time period between the first communication apparatus and the one or more communication apparatuses that communicate with the first communication apparatus.

2. The identification apparatus according to claim 1, wherein
the acquiring acquires information that includes an amount of information that is communicated between the plurality of communication apparatuses from a controller that controls a relay apparatus that relays communication between the plurality of communication apparatuses.

3. The identification apparatus according to claim 1, wherein
the identifying identifies as a server apparatus the first communication apparatus, when an amount of information that is output from the first communication apparatus is equal to or greater than an amount of information that is input to the first communication apparatus in communication in a specified time period between the first communication apparatus and each of the one or more communication apparatuses that communicate with the first communication apparatus.

4. The identification apparatus according to claim 1, the process further including:
identifying as a server apparatus a second communication apparatus that is any of the plurality of communication apparatuses and that communicates with the first communication apparatus, when an amount of information that is output from the second communication apparatus is equal to or greater than an amount of information that is input to the second communication apparatus in communication in a specified time period between the second communication apparatus and the one or more communication apparatuses that communicate with the second communication apparatus and that are different from the first communication apparatus when the first communication apparatus is identified as a server apparatus.

5. The identification apparatus according to claim 1, the process further including:
identifying as server apparatuses the first communication apparatus and a third communication apparatus that is any of the plurality of communication apparatuses, when there is a correlation between a communication amount of the first communication apparatus and a communication amount of the third communication apparatus in a specified time period.

6. The identification apparatus according to claim 5, wherein
the identifying the first communication apparatus and a third communication apparatus calculates a first threshold value on the basis of an average or variance of a communication amount for each specified time interval in a first time period for each of the first communication apparatus and the third communication apparatus, discriminates a time period of the specified time interval in which the communication amount is the first threshold value or greater than the first threshold value and the communication amount is maximal in the first time period, and identifies as server apparatuses the first communication apparatus and the third communication apparatus when the descriminated time period of the first communication apparatus agrees with the descriminated time period of the third communication apparatus.

7. The identification apparatus according to claim 1, the process further including:
judging that a failure has occurred in a fourth communication apparatus that communicates with the first communication apparatus, when an amount of information that is communicated in a specified time period between the first communication apparatus and the fourth communication apparatus is a specified threshold value or greater and when there is no information that is output from the fourth communication apparatus and there is information that is input to the forth communication apparatus in communication between the fourth communication apparatus and each of the one or more communication apparatuses that communicate with the fourth communication apparatus, in the case in which the first communication apparatus communicates with all of the plurality of communication apparatuses.

8. A non-transitory computer-readable recording medium having stored therein a program for causing a computer to execute a process, the process comprising:
acquiring information that includes an amount of information that is communicated between a plurality of communication apparatuses that communicate information; and
identifying as a server apparatus a first communication apparatus that is any of the plurality of communication apparatuses, when an amount of information that is output from the first communication apparatus is equal to or greater than an amount of information that is input to the first communication apparatus in communication in a specified time period between the first communication apparatus and the one or more communication apparatuses that communicate with the first communication apparatus.

9. An identification method comprising:
acquiring, by a computer, information that includes an amount of information that is communicated between a plurality of communication apparatuses that communicate information; and
identifying, by the computer, as a server apparatus a first communication apparatus that is any of the plurality of communication apparatuses, when an amount of information that is output from the first communication apparatus is equal to or greater than an amount of information that is input to the first communication apparatus in communication in a specified time period between the first communication apparatus and the one or more communication apparatuses that communicate with the first communication apparatus.
